(19) United States
(12) Patent Application Publication
(10) Pub. No.: US 2025/0240086 A1
(43) Pub. Date: Jul. 24, 2025

(54) TECHNIQUES FOR AIRCRAFT RELAYING

(71) Applicant: QUALCOMM Incorporated, San Diego, CA (US)

(72) Inventors: Kangqi LIU, San Diego, CA (US); Qiaoyu LI, Beijing (CN); Chao WEI, Beijing (CN); Hao XU, Beijing (CN)

(21) Appl. No.: 18/702,188

(22) PCT Filed: Dec. 29, 2021
(86) PCT No.: PCT/CN2021/142354

§ 371 Date: Apr. 17, 2024

(51) Int. Cl. H04B 7/185; H04W 4/90; H04W 74/0833

(52) U.S. Cl. CPC H04B 7/18504; H04W 4/90; H04W 74/0833

(57) ABSTRACT

Methods, systems, and devices for wireless communications are described. An aircraft may relay, to a terrestrial base station, an emergency message received from a user equipment (UE) located outside of a coverage area of the terrestrial base station. For example, the UE may be unable to transmit the emergency message to the terrestrial base station based on being located outside of the coverage area. Instead, the UE may transmit the emergency message to an aircraft within its communication range, and the aircraft may transmit the emergency message to the terrestrial base station. To support such emergency message communication, a non-terrestrial network (NTN) node may transmit aircraft information for the aircraft to the UE that enables the UE to transmit the emergency message to the aircraft. The NTN node may receive the aircraft information from the aircraft or the terrestrial base station.

### CROSS REFERENCE

The present application is a 371 national phase filing of International PCT Application No. PCT/CN2021/142354 by LIU et al., entitled “TECHNIQUES FOR AIRCRAFT RELAYING,” filed Dec. 29, 2021, which is assigned to the assignee hereof, and which is expressly incorporated by reference in its entirety herein.

### FIELD OF TECHNOLOGY

The following relates to wireless communications, including techniques for aircraft relaying.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support techniques for aircraft relaying. Generally, the described techniques provide for relaying messages (e.g., emergency messages, save our ship (SOS) messages) from a user equipment (UE) to a terrestrial base station via an aircraft while the UE is located outside of a coverage area of the terrestrial base station (e.g., outside of a cellular coverage area of a wireless communications system). For example, despite the UE being located outside of the coverage area, one or more aircraft may be traveling within a communication range of the UE. Accordingly, the UE may be configured to transmit an emergency message (e.g., a message comprising emergency information associated with the UE) to an aircraft within its communication range, and the aircraft may be configured to relay the emergency message to a terrestrial base station (e.g., directly, via a satellite, via one or more other aircraft).

To support such emergency message relaying, a non-terrestrial network (NTN) node (e.g., a satellite) may be configured to transmit aircraft information to the UE that enables the UE to transmit the emergency message to the aircraft. For example, the aircraft information may include a time and frequency resource to use to transmit the emergency message, a route of the aircraft, a flight time of the aircraft, or a location of the aircraft, among other types of aircraft information described herein. In some examples, the NTN node may receive the aircraft information from the aircraft or from the terrestrial base station. In response to receiving the aircraft information and being located outside of the coverage area, the UE may transmit the emergency message to the aircraft (e.g., using the time and frequency resource), and the aircraft may transmit (e.g., forward, relay) the emergency message to the terrestrial base station.

A method for wireless communication at a UE is described. The method may include receiving, from a network node of an NTN, a first message including aircraft information for an aircraft and associated with a transmission of a second message, from the UE to the aircraft, including emergency information associated with the UE and transmitting, in response to being located outside of a coverage area of a terrestrial base station and based on the aircraft information, the second message including the emergency information to the aircraft for relaying to the terrestrial base station.

An apparatus for wireless communication at a UE is described. The apparatus may include a processor, memory coupled with the processor, and instructions stored in the memory. The instructions may be operable, when executed by the processor, to cause the apparatus to receive, from a network node of an NTN, a first message including aircraft information for an aircraft and associated with a transmission of a second message, from the UE to the aircraft, including emergency information associated with the UE and transmit, in response to being located outside of a coverage area of a terrestrial base station and based on the aircraft information, the second message including the emergency information to the aircraft for relaying to the terrestrial base station.

Another apparatus for wireless communication at a UE is described. The apparatus may include means for receiving, from a network node of an NTN, a first message including aircraft information for an aircraft and associated with a transmission of a second message, from the UE to the aircraft, including emergency information associated with the UE and means for transmitting, in response to being located outside of a coverage area of a terrestrial base station and based on the aircraft information, the second message including the emergency information to the aircraft for relaying to the terrestrial base station.

A non-transitory computer-readable medium storing code for wireless communication at a UE is described. The code may include instructions executable by a processor to receive, from a network node of an NTN, a first message including aircraft information for an aircraft and associated with a transmission of a second message, from the UE to the aircraft, including emergency information associated with the UE and transmit, in response to being located outside of a coverage area of a terrestrial base station and based on the aircraft information, the second message including the emergency information to the aircraft for relaying to the terrestrial base station.

In some examples of the method, apparatuses, and non-transitory computer-readable medium described herein, the transmitting of the second message including the emergency information may include operations, features, means, or instructions for transmitting the second message including the emergency information using a resource indicated by the aircraft information.

Some examples of the method, apparatuses, and non-transitory computer-readable medium described herein may further include operations, features, means, or instructions for receiving, from the network node of the NTN and based on being in an idle state or an inactive state, a third message indicating for the UE to transmit the second message including the emergency information using the resource indicated by the aircraft information, where transmitting the second message uses the resource.

In some examples of the method, apparatuses, and non-transitory computer-readable medium described herein, the aircraft information indicates a first resource for transmitting a random access channel (RACH) preamble to the aircraft and a format of the RACH preamble and the method, apparatuses, and non-transitory computer-readable medium may include further operations, features, means, or instructions for transmitting, to the aircraft, a third message including the RACH preamble as part of a RACH procedure with the aircraft and receiving, from the aircraft and based on the RACH procedure, an indication of a second resource for transmitting the second message including the emergency information, where the second message may be transmitted using the second resource.

Some examples of the method, apparatuses, and non-transitory computer-readable medium described herein may further include operations, features, means, or instructions for receiving, from the network node of the NTN, a second indication to initiate the RACH procedure with the aircraft, where the third message including the RACH preamble may be transmitted to the aircraft based on receiving the second indication.

Some examples of the method, apparatuses, and non-transitory computer-readable medium described herein may further include operations, features, means, or instructions for receiving, from the network node of the NTN, a second indication to refrain from initiating the RACH procedure with the network node of the NTN, where the third message including the RACH preamble may be transmitted to the aircraft based on receiving the second indication.

Some examples of the method, apparatuses, and non-transitory computer-readable medium described herein may further include operations, features, means, or instructions for monitoring for the first message including the aircraft information from the network node of the NTN based on being located outside of the coverage area of the terrestrial base station, where the first message including the aircraft information may be received while the UE may be located outside of the coverage area of the terrestrial base station based on the monitoring.

Some examples of the method, apparatuses, and non-transitory computer-readable medium described herein may further include operations, features, means, or instructions for receiving, from the network node of the NTN, an indication that a first timing associated with transmitting the second message to the aircraft may be asynchronous with a second timing associated with receiving the first message from the network node of the NTN, where transmitting the second message may be based on receiving the indication.

In some examples of the method, apparatuses, and non-transitory computer-readable medium described herein, the aircraft information indicates a route of the aircraft, a flight time associated with the aircraft, a location of the aircraft, timing advance information associated with transmitting the second message including the emergency information, or a combination thereof.

Some examples of the method, apparatuses, and non-transitory computer-readable medium described herein may further include operations, features, means, or instructions for receiving, from the network node of the NTN, system information indicating that the first message including the aircraft information and control signaling may be received from the network node of the NTN, where the network node of the NTN includes a satellite.

In some examples of the method, apparatuses, and non-transitory computer-readable medium described herein, a resource used to transmit the second message including the emergency information may be an uplink resource or a sidelink resource based on a configuration of the aircraft.

In some examples of the method, apparatuses, and non-transitory computer-readable medium described herein, the first message includes second aircraft information for a second aircraft and the method, apparatuses, and non-transitory computer-readable medium may include further operations, features, means, or instructions for selecting the aircraft from at least the aircraft and the second aircraft to which to transmit the second message including the emergency information based on the aircraft information and the second aircraft information.

A method for wireless communication at an aircraft is described. The method may include receiving, from a UE, a first message including emergency information associated with the UE, the first message including the emergency information received over a resource allocated based on a set of parameters associated with the aircraft and transmitting, to a terrestrial base station, a second message including the emergency information based on receiving the first message.

An apparatus for wireless communication at an aircraft is described. The apparatus may include a processor, memory coupled with the processor, and instructions stored in the memory. The instructions may be operable, when executed by the processor, to cause the apparatus to receive, from a UE, a first message including emergency information associated with the UE, the first message including the emergency information received over a resource allocated based on a set of parameters associated with the aircraft and transmit, to a terrestrial base station, a second message including the emergency information based on receiving the first message.

Another apparatus for wireless communication at an aircraft is described. The apparatus may include means for receiving, from a UE, a first message including emergency information associated with the UE, the first message including the emergency information received over a resource allocated based on a set of parameters associated with the aircraft and means for transmitting, to a terrestrial base station, a second message including the emergency information based on receiving the first message.

A non-transitory computer-readable medium storing code for wireless communication at an aircraft is described. The code may include instructions executable by a processor to receive, from a UE, a first message including emergency information associated with the UE, the first message including the emergency information received over a resource allocated based on a set of parameters associated with the aircraft and transmit, to a terrestrial base station, a second message including the emergency information based on receiving the first message.

Some examples of the method, apparatuses, and non-transitory computer-readable medium described herein may further include operations, features, means, or instructions for transmitting, to the terrestrial base station or a network node of an NTN, a third message indicating a capability of the aircraft to relay the second message including the emergency information to the terrestrial base station, where receiving the first message may be based on transmitting the third message.

Some examples of the method, apparatuses, and non-transitory computer-readable medium described herein may further include operations, features, means, or instructions for transmitting, to the terrestrial base station or a network node of an NTN, a third message indicating the set of parameters associated with the aircraft, the set of parameters associated with the aircraft including a route of the aircraft, a flight time associated with the aircraft, a location of the aircraft, or a combination thereof, where receiving the first message may be based on transmitting the third message.

Some examples of the method, apparatuses, and non-transitory computer-readable medium described herein may further include operations, features, means, or instructions for receiving, from the terrestrial base station or a network node of an NTN, an indication of the resource allocated for the first message including the emergency information and monitoring the resource for the first message including the emergency information based on receiving the indication, where the first message including the emergency information may be received over the resource based on the monitoring.

Some examples of the method, apparatuses, and non-transitory computer-readable medium described herein may further include operations, features, means, or instructions for receiving, from the terrestrial base station or a network node of an NTN, a first indication of a first resource for receiving a RACH preamble from the UE and a format of the RACH preamble and monitoring, based on receiving the first indication, the first resource for the RACH preamble as part of a RACH procedure with the UE, where the resource may be allocated for the first message including the emergency information based on the RACH procedure.

Some examples of the method, apparatuses, and non-transitory computer-readable medium described herein may further include operations, features, means, or instructions for receiving, from the UE and based on the monitoring, a third message including the RACH preamble as part of the RACH procedure with the UE and transmitting, to the UE and based on performing the RACH procedure, a second indication of the resource allocated for the first message including the emergency information, where the first message including the emergency information may be received over the resource based on transmitting the second indication.

Some examples of the method, apparatuses, and non-transitory computer-readable medium described herein may further include operations, features, means, or instructions for receiving, from the terrestrial base station or a network node of an NTN, an indication to enable reception of the first message including the emergency information from the UE and transmission of the second message including the emergency information to the terrestrial base station.

Some examples of the method, apparatuses, and non-transitory computer-readable medium described herein may further include operations, features, means, or instructions for enabling reception of the first message including the emergency information from the UE and transmission of the second message including the emergency information to the terrestrial base station based on a location of the aircraft satisfying a condition configured by the terrestrial base station or a network node of an NTN.

In some examples of the method, apparatuses, and non-transitory computer-readable medium described herein, the transmitting of the second message including the emergency information to the terrestrial base station may include operations, features, means, or instructions for transmitting the second message including the emergency information to a second aircraft or a network node of an NTN for relaying the second message including the emergency information to the terrestrial base station.

A method for wireless communication at a network node of an NTN is described. The method may include receiving, from a terrestrial base station or an aircraft, a first message including aircraft information for the aircraft and associated with a transmission of a second message, from a UE to the aircraft, including emergency information associated with the UE and transmitting, to the UE, a third message including the aircraft information based on receiving the first message including the aircraft information.

An apparatus for wireless communication at a network node of an NTN is described. The apparatus may include a processor, memory coupled with the processor, and instructions stored in the memory. The instructions may be operable, when executed by the processor, to cause the apparatus to receive, from a terrestrial base station or an aircraft, a first message including aircraft information for the aircraft and associated with a transmission of a second message, from a UE to the aircraft, including emergency information associated with the UE and transmit, to the UE, a third message including the aircraft information based on receiving the first message including the aircraft information.

Another apparatus for wireless communication at a network node of an NTN is described. The apparatus may include means for receiving, from a terrestrial base station or an aircraft, a first message including aircraft information for the aircraft and associated with a transmission of a second message, from a UE to the aircraft, including emergency information associated with the UE and means for transmitting, to the UE, a third message including the aircraft information based on receiving the first message including the aircraft information.

A non-transitory computer-readable medium storing code for wireless communication at a network node of an NTN is described. The code may include instructions executable by a processor to receive, from a terrestrial base station or an aircraft, a first message including aircraft information for the aircraft and associated with a transmission of a second message, from a UE to the aircraft, including emergency information associated with the UE and transmit, to the UE, a third message including the aircraft information based on receiving the first message including the aircraft information.

Some examples of the method, apparatuses, and non-transitory computer-readable medium described herein may further include operations, features, means, or instructions for receiving, from the terrestrial base station, a fourth message including an indication of an area that may be outside of a coverage area of the terrestrial base station, where transmitting the third message including the aircraft information to the UE may be based on receiving the fourth message.

In some examples of the method, apparatuses, and non-transitory computer-readable medium described herein, the transmitting of the third message including the aircraft information may include operations, features, means, or instructions for broadcasting the third message including the aircraft information to one or more UEs located in an area that may be outside of a coverage area of the terrestrial base station, the one or more UEs including the UE.

In some examples of the method, apparatuses, and non-transitory computer-readable medium described herein, the aircraft information indicates a first resource for the UE to use to transmit the second message including the emergency information to the aircraft, a second resource for the UE to use to transmit a RACH preamble to the aircraft, a format of the RACH preamble, a route of the aircraft, a flight time associated with the aircraft, a location of the aircraft, timing advance information associated with transmitting the second message including the emergency information to the aircraft, or a combination thereof.

### BRIEF DESCRIPTION OF THE DRAWINGS

FIGS. 1 and 2 illustrate examples of wireless communications systems that support techniques for aircraft relaying in accordance with aspects of the present disclosure.

FIG. 3 illustrates an example of a process flow that supports techniques for aircraft relaying in accordance with aspects of the present disclosure.

FIGS. 4 and 5 show block diagrams of devices that support techniques for aircraft relaying in accordance with aspects of the present disclosure.

FIG. 6 shows a block diagram of a communications manager that supports techniques for aircraft relaying in accordance with aspects of the present disclosure.

FIG. 7 shows a diagram of a system including a device that supports techniques for aircraft relaying in accordance with aspects of the present disclosure.

FIGS. 8 and 9 show block diagrams of devices that support techniques for aircraft relaying in accordance with aspects of the present disclosure.

FIG. 10 shows a block diagram of a communications manager that supports techniques for aircraft relaying in accordance with aspects of the present disclosure.

FIG. 11 shows a diagram of a system including a device that supports techniques for aircraft relaying in accordance with aspects of the present disclosure.

FIGS. 12 and 13 show block diagrams of devices that support techniques for aircraft relaying in accordance with aspects of the present disclosure.

FIG. 14 shows a block diagram of a communications manager that supports techniques for aircraft relaying in accordance with aspects of the present disclosure.

FIG. 15 shows a diagram of a system including a device that supports techniques for aircraft relaying in accordance with aspects of the present disclosure.

FIGS. 16 through 23 show flowcharts illustrating methods that support techniques for aircraft relaying in accordance with aspects of the present disclosure.

### DETAILED DESCRIPTION

Some wireless communications systems may support non-terrestrial network (NTN) communications in which a user equipment (UE) may communicate with nodes of the NTN, such as a satellite, a high-altitude platform base station, a balloon, an aircraft, a drone, or an unmanned aerial vehicle, among other NTN nodes. Additionally or alternatively, some wireless communications systems may support air-to-ground (ATG) communications in which a terrestrial communication device (e.g., a UE, a terrestrial base station) may communicate with an aircraft traveling in the air. In some examples, ATG communications may be associated with higher throughput, reduced power consumption, and reduced latency compared to NTN communications, for example, due to ATG communications traveling smaller distances compared to distances traveled by NTN communications. For example, latency may be reduced because a distance between an aircraft and a terrestrial communication device may be smaller than a distance between an NTN node and a terrestrial communication device.

In some examples, a wireless communications system may support the communication of emergency messages (e.g., SOS messages) while a UE is located outside of a coverage area of terrestrial base station (e.g., outside of any terrestrial base station coverage areas of the wireless communications system). In some cases, the wireless communications system may support such emergency message communication via an NTN, such as an Iridium satellite system. For example, a UE, such as a satellite phone, transmit an NTN communication including the emergency message to an Iridium satellite, and the Iridium satellite may transmit (e.g., forward, relay) the emergency message to the terrestrial base station. In NTN networks, downlink signals may be easier to communicate from the NTN node to the UE than uplink signals are to communicate from the UE to the NTN node because of the power and antenna constraints at the UE. In some cases, the satellite phone may have strict (e.g., relatively high) transmission power constraints to increase a likelihood that the Iridium satellite receives the emergency message and may require human-assisted operations to point an antenna of the UE or satellite phone towards the Iridium satellite to avoid blockage of the emergency message. As a result, communicating emergency messages using an Iridium satellite system may be associated with relatively high power consumption and may be unfeasible for many UEs, such as common cell phones or UEs implementing machine type communication (MTC) messaging.

In some other cases, the wireless communications system may support emergency message communication while the UE is located outside of the coverage area via a fifth generation (5G) NTN. In some examples, 5G NTNs may support the communication of such emergency messages by UEs that do not support Iridium-based messaging. However, in some cases, communicating emergency messages via a 5G NTN may suffer from the relatively high power consumption and latency associated with NTN communications. Additionally, in some cases, deployment of 5G NTNs may be associated with high costs, for example, due to deploying new NTN nodes (e.g., launching new satellites) and building new gateways.

Techniques, systems, and devices are described herein for using ATG communications to communicate an emergency message from a UE located outside of a coverage area of a terrestrial base station to the terrestrial base station. For example, despite the UE being located outside of the coverage area, one or more aircraft may be traveling within a communication range of the UE. The UE may be configured to transmit an emergency message to an aircraft within its communication range, and the aircraft may transmit (e.g., relay, forward) the emergency message to the terrestrial base station (e.g., directly, via an NTN node, via one or more other aircraft).

To support such emergency message relaying, an NTN node (e.g., a satellite) may be configured to receive aircraft information for an aircraft that enables the UE to transmit the emergency message to the aircraft. For example, the aircraft information may indicate one or more of a first resource (e.g., an uplink resource, a sidelink resource) for transmitting the emergency message, a second resource for transmitting a random access channel (RACH) preamble as part of a RACH procedure to select the first resource, a RACH preamble format, a route of the aircraft, a flight time of the aircraft, a location of the aircraft, or timing advance information, among other types of aircraft information for transmitting the emergency message to the aircraft. In some examples, the NTN node may receive the aircraft information from the aircraft or from the terrestrial base station. The NTN node may transmit the aircraft information to the UE, for example, based on the UE being located outside of the coverage area. In response to receiving the aircraft information and being located outside of the coverage area, the UE may transmit the emergency message to the aircraft, and the aircraft may transmit (e.g., forward, relay) the emergency message to the terrestrial base station.

Aspects of the subject matter described in this disclosure may be implemented to realize one or more of the following potential improvements, among others. The techniques employed by the described communication devices may enable the relaying of emergency messages to a terrestrial base station via an aircraft, which may increase coverage, reduce power consumption, and reduce latency associated with communicating emergency messages from a UE located outside of a coverage area of a terrestrial base station. For example, using an aircraft to relay emergency messages may expand a coverage area in which a UE may communicate an emergency message to a terrestrial base station. Additionally, transmitting emergency messages to a terrestrial base station via an aircraft may avoid a UE-to-satellite communication link by instead using a UE-to-aircraft communication link. Thereby reducing power consumption at the UE and latency of the message by implementing ATG communications rather than NTN communications to communicate the emergency message. In some examples, using an aircraft to relay emergency messages may also reduce deployment costs as ATG communication deployments may be less expensive than NTN communication deployments. In some examples, relaying emergency messages via aircraft may improve coordination between communication devices, increase resource utilization efficiency, increase spectral efficiency, and increase data rates, among other benefits.

Aspects of the disclosure are initially described in the context of wireless communications systems. Aspects of the disclosure are additionally described in the context of a process flow. Aspects of the disclosure are further illustrated by and described with reference to apparatus diagrams, system diagrams, and flowcharts that relate to techniques for aircraft relaying.

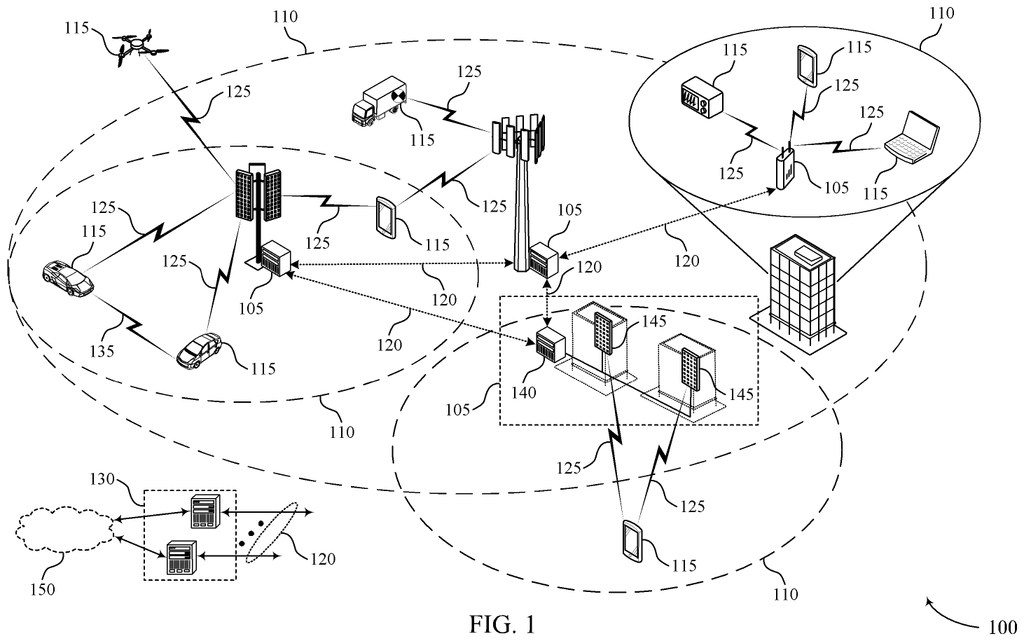

FIG. 1 illustrates an example of a wireless communications system 100 that supports techniques for aircraft relaying in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node or a network entity. As used herein, a network node or a network entity may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, aircraft, or meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ−N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The wireless communications system 100 may support NTN communications. For example, the wireless communications system 100 may include base stations 105 that function as NTN nodes (e.g., non-terrestrial base stations). In some examples, an NTN node may communicate with base stations 105 (also referred to as gateways in NTNs) and UEs 115 (or other high altitude or terrestrial communications devices). An NTN node may be any suitable type of communication device configured to relay communications between different end nodes in a wireless communication system. In some cases, an NTN node may be an example of a space satellite, a high-altitude platform base station, a balloon, a dirigible, an airplane, a drone, an unmanned aerial vehicle, and the like. In some examples, an NTN node may be in a geosynchronous or geostationary earth orbit, a low earth orbit or a medium earth orbit. In some cases, an NTN node may be a multi-beam satellite configured to provide service for multiple service beam coverage areas in a predefined geographical service area. An NTN node may be any distance away from the surface of the earth.

The wireless communications system 100 may support ATG communications. For example, the wireless communications system 100 may include aircraft that support communicating with a UE 115, a base station 105, an NTN node, or a combination thereof. In some examples, an aircraft may be configured to operate as and perform one or more functions of a base station 105. Here, communications between the aircraft and a UE 115 may constitute uplink communications and downlink communications. In some examples, an aircraft may be configured to operate as and perform one or more functions of a UE 115. Here, communications between the aircraft and a UE 115 may constitute sidelink communications, and communications between the aircraft and a base station 105 may constitute uplink communications and downlink communications. In some examples, an aircraft may be connected or equipped with a customer premises equipment (CPE).

In some examples, ATG communications may be associated with relatively lower costs, higher throughput, lower power consumption, and lower latency as compared to satellite communications (e.g., NTN communications where the NTN node is a satellite). For example, ATG communications may travel (e.g., propagate) over smaller distances than satellite communications (e.g., an aircraft may be located closer to the earth than a satellite). As a result, ATG communications may be communicated relatively faster and may be associated with smaller delays (e.g., propagation delays, round trip delays, and the like) and timing and frequency variations compared to satellite communications. Additionally, the deployment of aircraft that support ATG communications (e.g., equipping aircraft) may be cheaper than the deployment of satellites.

An aircraft may support various types of wireless communication traffic. For example, an aircraft may support in-flight passenger communications, such as during commercial flights or business aviation. Additionally or alternatively, an aircraft may support air traffic control communications (e.g., over aviation licensed bands). Additionally or alternatively, an aircraft may support airline operation communications, such as aircraft maintenance information, flight planning information, or weather information, among other information related to airline operation.

ATG communications may extend a coverage of the wireless communications system 100. For example, an aircraft may travel near or over areas excluded from coverage areas 110 of base stations 105 of the wireless communications system 100 (e.g., terrestrial base stations of the wireless communications system 100). The aircraft may support the relaying of messages received from a UE 115 located in an area excluded from the coverage areas 110 (e.g., located outside of any coverage area 110) to a base station 105. Accordingly, a UE 115 located outside of coverage areas 110 of terrestrial base stations of the wireless communications system 100 may still be able to communicate messages with a terrestrial base station via an aircraft. In some examples, an aircraft may support such relaying by enabling the line-of-sight (LOS) propagation of wireless communications. For example, an aircraft traveling at cruising altitude (e.g., at approximately ten kilometers) may enable LOS propagation of messages between terrestrial communication devices (e.g., between a UE 115 and a terrestrial base station) for over two hundred kilometers. A density of aircraft varies region-by-region (e.g., denser closer to urban areas), but may be relatively denser during the day rather than the night. For example, at least one aircraft may be visible within fifty to one hundred kilometers of many remote areas in the United States (e.g., during the day). Accordingly, a UE 115 located outside of a coverage area 110 of a terrestrial base station may be relatively likely to be able to communicate with the at least one aircraft. Thus the coverage area 110 of the terrestrial base station (e.g., and the wireless communications system 100) may be extended.

The wireless communications system 100 may support NTN-assisted aircraft relaying (e.g., satellite-assisted aircraft relaying) of emergency messages. For example, an NTN node (e.g., a satellite) may be configured to transmit aircraft information for an aircraft to a UE 115 that is located outside of a coverage area 110 of a terrestrial base station. The aircraft information may enable the UE 115 to transmit an emergency message (e.g., a message that includes emergency information associated with the UE 115) to the aircraft while located outside of the coverage area 110. For example, the UE 115 may use the aircraft information to determine a resource (e.g., and a transmission direction) for transmitting the emergency message to the aircraft. The aircraft may receive the emergency message and may transmit (e.g., relay, forward) the emergency message to the terrestrial base station.

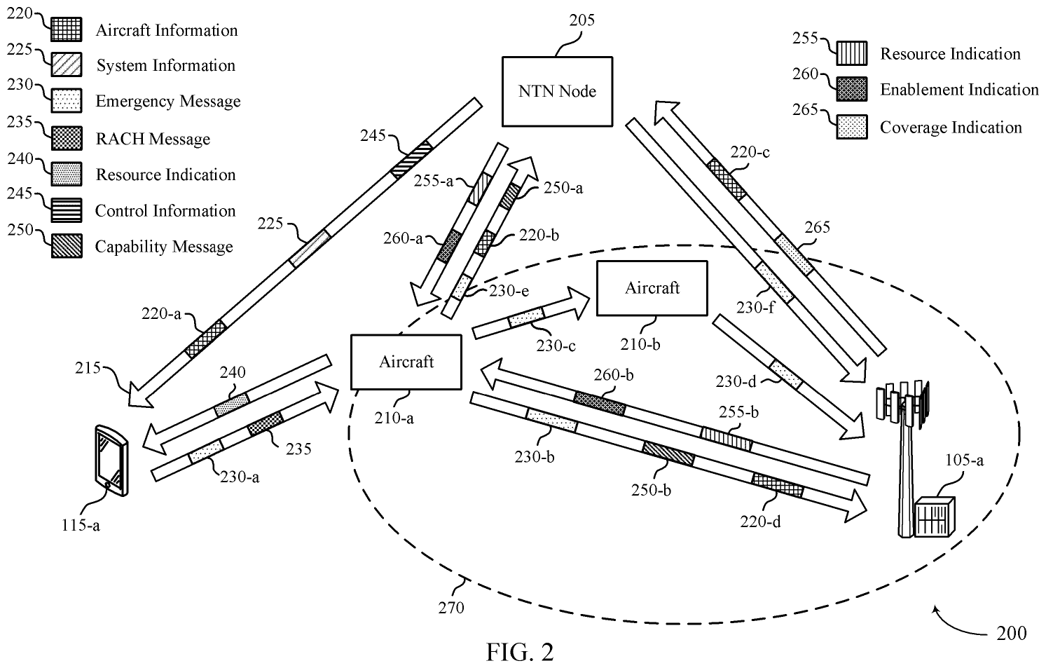

FIG. 2 illustrates an example of a wireless communications system 200 that supports techniques for aircraft relaying in accordance with aspects of the present disclosure. The wireless communications system 200 may implement or be implemented by aspects of the wireless communications system 100 described with reference to FIG. 1. For example, the wireless communications system 200 may include a base station 105-a and a UE 115-a, which may be examples of the corresponding devices described with reference to FIG. 1. Additionally, the wireless communications system 200 may include an NTN nodes 205, an aircraft 210-a, and an aircraft 210-b, which may be examples of an NTN node and an aircraft described with reference to FIG. 1, respectively. The wireless communications system 200 may support position determination procedures using relative positioning to support improvements to power consumption, battery life, processing capability, coordination between devices, and resource utilization efficiency, among other benefits.

The wireless communications system 200 may support communications between the wireless devices of the wireless communications system 200 via communication links 215. For example, the wireless communications system 200 may support communications, via respective communication links 215, between the UE 115-a and the NTN node 205, between the UE 115-a and the aircraft 210-a, between the aircraft 210-a and the aircraft 210-b, between the aircraft 210-a and the NTN node 205, between the aircraft 210-a and the base station 105-a, between the aircraft 210-b and the base station 105-a, and between the NTN node 205 and the base station 105-a. In some examples, one or more of the communication links 215 may be examples of a communication link 125 as described with reference to FIG. 1. In some examples, one or more of the communication links 215 may be examples of a D2D communication link 135 as described with reference to FIG. 1 (e.g., to support sidelink communications between respective wireless devices).

The wireless communications system 200 may support NTN communications and ATG communications. For example, communications with the NTN node 205 may constitute NTN communications, and communications between the aircraft 210 and a terrestrial communication device (e.g., the UE 115-a, the base station 105-a) may constitute ATG communications.

The wireless communications system 200 may support the relaying of an emergency message 230 via an aircraft 210. For example, the UE 115-a may be configured to transmit an emergency message 230-a to the aircraft 210-a for relaying to the base station 105-a, which may be an example of a terrestrial base station (e.g., a base station 105 located on the earth). The emergency message 230-a may include emergency information associated with the UE 115-a, such as a location of the UE 115-a (e.g., a global navigation satellite system (GNSS) position of the UE 115-a), audio recordings, images, or an indication that the emergency message 230-a is associated with an emergency, among other types of emergency information associated with the UE 115-a. In some examples, the emergency message 230-a may be an SOS message.

The communication of the emergency message 230-a via the aircraft 210-a may be NTN-assisted. For example, the NTN node 205 may be configured to transmit aircraft information 220-a to the UE 115-a (e.g., via system information, such as a system information block (SIB)) that enables the UE 115-a to transmit the emergency message 230-a to the aircraft 210-a. For instance, the aircraft information 220-a may include information for the aircraft 210-a, such as a route of the aircraft 210-a, a flight time of the aircraft 210-a, a location of the aircraft 210-a, or a combination thereof. Such information may enable the UE 115-a, for example, to determine whether the aircraft 210-a is within a communication range of the UE 115-a or determine a direction to transmit the emergency message 230-a (e.g., a beam direction). In some examples, the aircraft information 220-a may include timing advance information associated with transmitting the emergency message 230-a. For example, the aircraft information 220-a may indicate the UE 115-a to adjust (e.g., advance, delay) a timing of the emergency message 230-a transmission to the aircraft 210-a to increase, for example, subframe timing alignment between the UE 115-a and the aircraft 210-a. An NTN may be used to communicate the aircraft information because the NTN may be a relatively reliable way to communicate the aircraft information to a UE outside of a coverage area of a terrestrial base station. While it may be challenging for some UEs to transmit uplink messages in an NTN, it may be less challenging for a satellite (or other node) to transmit downlink message to the UE in an NTN. Thus, the network node in the NTN may be configured to transmit or broadcast aircraft information (e.g., as part of a system information block) to areas that may be outside of the coverage area of a terrestrial base station.

The aircraft information 220-a may additionally or alternatively include information associated with a resource for transmitting the emergency message 230-a. In some examples, the aircraft information 220-a may indicate the resource for the UE 115-a to use to transmit the emergency message 230-a. For example, the aircraft information 220-a may indicate a preserved resource over which the UE 115-a and the aircraft 210-a may communicate the emergency message 230-a. In some examples, the preserved resource may be an uplink resource. For example, if the aircraft 210-a is configured to operate as a base station 105, the UE 115-a and the aircraft 210-a may communicate downlink and uplink messages. Accordingly, the aircraft information 220-a may indicate a preserved uplink resource that the UE 115-a may use to transmit the emergency message 230-a, and the UE 115-a may transmit the emergency message 230-a to the aircraft 210-a using the preserved uplink resource. In some other examples, the preserved resource may be a sidelink resource. For example, if the aircraft 210-a is configured to operate as a UE 115, the UE 115-a and the aircraft 210-a may communicate sidelink messages. Accordingly, the aircraft information 220-a may indicate a preserved sidelink resource that the UE 115-a may use to transmit the emergency message 230-a (e.g., in accordance with a Mode 1 sidelink resource allocation scheme), and the UE 115-a may transmit the emergency message 230-a to the aircraft 210-a using the preserved sidelink resource.

The aircraft 210-a may be configured with the preserved resource by the NTN node 205 or the base station 105-a. For example, the NTN node 205 may transmit a resource indication 255-a to the aircraft 210-a that indicates the preserved resource. Alternatively, the base station 105-a may transmit a resource indication 255-b that indicates the preserved resource. In response to receiving a resource indication 255, the aircraft 210-a may monitor the preserved resource for the emergency message 230-a and may receive the emergency message 230-a over the preserved resource as a result of the monitoring.

In some examples, the aircraft information 220-a may indicate a second resource for the UE 115-a to transmit a RACH preamble to the aircraft 210-a as part of a RACH procedure. The resource for transmitting the emergency message 230-a may be determined based on the RACH procedure. For example, the aircraft information 220-a may indicate a format of the RACH preamble and a frequency and time of the second resource. Based on receiving the aircraft information 220-a, the UE 115-a may transmit a RACH message 235 (e.g., a RACH msg1) using the second resource that includes the RACH preamble having the indicated format. The UE 115-a and the aircraft 210-a may perform the RACH procedure in accordance with the RACH preamble to establish a link between the UE 115-a and the aircraft 210-a. For example, the UE 115-a and the aircraft 210-a may perform the RACH procedure to establish timing synchronization between the UE 115-a, select beams for beamforming communications between the UE 115-a and the aircraft 210-a, and the like. Based on performing the RACH procedure to establish the link, the aircraft 210-a may transmit a resource indication 240 to the UE 115-a that indicates the resource for transmitting the emergency message 230-a. In some examples, the resource indication 240 may be an uplink grant. In response to receiving the resource indication 240, the UE 115-a may transmit the emergency message 230-a to the aircraft 210-a using the resource.

The aircraft 210-a may be configured with second resource for receiving the RACH message 235 by the NTN node 205 or the base station 105-a. For example, resource indication 255-a or the resource indication 255-b may indicate the second resource. Additionally, the resource indication 255-a or the resource indication 255-b may indicate the format of the RACH preamble included in the RACH message 235. Here, the aircraft 210-a may monitor the second resource for the RACH message 235 in response to receiving the resource indication 255-a or the resource indication 255-b and may receive the RACH message 235 as part of the RACH procedure as a result of the monitoring.

The NTN node 205 may receive information included in the aircraft information 220-a from various sources. For example, the aircraft 210-a may transmit, to the NTN node 205, aircraft information 220-b that corresponds to the aircraft information 220-a (e.g., via an aircraft-to-satellite link). Additionally or alternatively, the base station 105-a may transmit aircraft information 220-c to the NTN node 205 that corresponds to the aircraft information 220-a. In some examples, the base station 105-a may transmit the aircraft information 220-c in accordance with application layer protocols (e.g., associated with an aircraft information data base or an aircraft information server). In some examples, the base station 105-a may transmit the aircraft information 220-c using radio access network (RAN) based signaling, such as using RRC signaling, a MAC-control element (MAC-CE), or downlink control information (DCI). In some examples, the aircraft 210-a may transmit aircraft information 220-d to the base station 105-a that corresponds to the aircraft information 220-a, and the base station 105-a may forward the aircraft information 220-d to the NTN node 205 via the aircraft information 220-c.

The UE 115-a may be configured to transmit the emergency message 230-a based on being located outside of a coverage area 270 of the base station 105-a. For example, the base station 105-a may provide the coverage area 270 corresponding to a geographic area over which the base station 105-a may communicate signals with the UE 115-a and the aircraft 210. The UE 115-a may be located outside of the coverage area 270 and may thus be unable to communicate with the base station 105-a. In the example of FIG. 2, being located outside of the coverage area 270 may correspond to being located outside of any coverage area 270 of any base station 105 of the wireless communications system 200. In other words, the UE 115-a may be in a location such that the UE 115-a is unable to communicate with any terrestrial base station of the wireless communications system 200. The UE 115-a may determine that it is located outside of the coverage area 270 and monitor for the aircraft information 220-a in response to being located outside of the coverage area 270. Based on the monitoring, the UE 115-a may receive the aircraft information 220-a and transmit the emergency message 230-a to the aircraft 210-a in accordance with the aircraft information 220-a.

The NTN node 205 may be configured to transmit information to the UE 115-a to support the transmission of the emergency message 230-a based on the UE 115-a being located outside of the coverage area 270. For example, the base station 105-a may transmit a coverage indication 265 that enables the NTN node 205 to determine an area outside of the coverage area 270. For instance, the coverage indication 265 may indicate the coverage area 270 provided by the base station 105-a, and the NTN node 205 may determine (e.g., calculate, compute, deduce) the area outside of the coverage area 270, for example, based on (e.g., using) the boundaries of the coverage area 270. Alternatively, the coverage indication 265 may indicate the area outside of the coverage area 270. In some examples, the coverage indication 265 may indicate the coverage areas 270 of the wireless communications system 200 or areas that are outside of the coverage areas 270 of the wireless communications system 200. In some cases, the base station 105-a may transmit the coverage indication 265 in accordance with application layer protocols (e.g., associated with a coverage area data base or a coverage area server). In some cases, the base station 105-a may transmit the coverage indication 265 using RAN-based signaling, such as using RRC signaling, a MAC-CE, or DCI.

In response to receiving the coverage indication 265, the NTN node 205 may determine the area outside of the coverage area 270 and may broadcast aircraft information 220 to UEs 115 located outside of the coverage area 270 (e.g., located in the area outside of the coverage area 270). For example, the NTN node 205 may broadcast the aircraft information 220-a to the area outside of the coverage area 270, and the UE 115-a may receive the aircraft information 220-a based on being located in the area outside of the coverage area 270. In some examples, the NTN node 205 may be configured to periodically broadcast the aircraft information 220 in accordance with a configured periodicity. In some examples, the NTN node 205 may broadcast the aircraft information 220 in response to receiving the aircraft information 220 from an aircraft 210 (e.g., the aircraft information 220-b) or from a terrestrial base station (e.g., the aircraft information 220-c).

The NTN node 205 may transmit additional information to the UE 115-a that supports the communication of the emergency message 230-a via the aircraft 210-a. For example, the NTN node 205 may transmit, to the UE 115-a, system information 225 indicating that messages received from the NTN node 205 (e.g., the aircraft information 220-a, the system information 225, control information 245) are from a satellite. In some examples, the NTN node 205 may transmit the system information 225 in a master information block (MIB), a SIB (e.g., a SIB1), or a combination thereof. In some examples, the UE 115-a may refrain from establishing a UE-to-satellite link with the NTN node 205 (e.g., refrain from performing a RACH procedure with the NTN node 205) based on the system information 225 indicating that the NTN node 205 is a satellite. For example, the UE 115-a may be configured to perform a RACH procedure with a wireless device from which the UE 115-a receives a MIB, a SIB, etc., to be able to transmit the emergency message 230-a to the wireless device. But the UE 115-a may be configured to avoid transmitting messages to a satellite, for example, to reduce power consumption at the UE 115-a and to reduce latency. Accordingly, in some cases, the UE 115-a may refrain from performing a RACH procedure with the NTN node 205 in response to the system information 225 indicating that the NTN node 205 is a satellite. Instead, the UE 115-a may use the aircraft information 220-a to initiate a RACH procedure with the aircraft and transmit the emergency message 230-a to the aircraft 210-a (e.g., using a preserved resource, based on a RACH procedure with the aircraft 210-a).

The NTN node 205 may also transmit control information 245 to the UE 115-a that supports the communication of the emergency message 230-a via the aircraft 210-a. In some examples, the control information 245 may indicate for the UE 115-a to refrain from performing the RACH procedure with the NTN node 205 (e.g., based on the NTN node 205 being a satellite), and the UE 115-a may transmit the RACH message 235 to the aircraft 210-a (e.g., to initiate the RACH procedure with the aircraft 210-a) in response to receiving the control information 245. In some other examples, the control information 245 may indicate for the UE 115-a to initiate the RACH procedure with the aircraft 210-a (e.g., in accordance with the aircraft information 220-a) instead of the NTN node 205, and the UE 115-a may transmit the RACH message 235 in response to receiving the control information 245. In some cases, the control information 245 may indicate for the UE 115-a to transmit the emergency message 230-a using resource indicated by the aircraft information 220-a (e.g., the preserved uplink resource, the preserved sidelink resource), and the UE 115—may transmit the emergency message 230-a using the indicated resource in response to receiving the control information 245. In some examples, the UE 115-a may be in an idle state (e.g., an RRC_IDLE state) or an inactive state (e.g., an RRC_INACTIVE state) when the UE 115-a receives the control information 245 (e.g., and the system information 225, the aircraft information 220-a, or both).

In some examples, the control information 245 may indicate that a first timing for receiving messages from the NTN node 205 is asynchronous with a second timing for transmitting messages to the aircraft 210-a. Here, the UE 115-a may receive the aircraft information 220-a, the system information 225, the control information 245, or a combination thereof, in accordance with the first timing and may communicate with the aircraft 210-a (e.g., communicate the emergency message 230-a, the RACH message 235, the resource indication 240, or a combination thereof) in accordance with the second timing. In some examples, the second timing may be synchronized with a GNSS system or a satellite communications system with respect to an absolute time.

In some examples, the aircraft information 220-a may include information associated with multiple aircraft 210. For example, the aircraft information 220-a may include additional information for one or more additional aircraft 210 (e.g., the aircraft 210-b) that enables the communication of emergency messages 230 between the UE 115-a and the one or more additional aircraft 210. Here, the UE 115-a may select at least one the aircraft 210 from the aircraft 210-a and the one or more additional aircraft 210 (e.g., may select the aircraft 210-a) and may transmit the emergency message 230-a to the selected at least one aircraft 210 for relaying to the base station 105-a. In some examples, the UE 115-a may select the at least one aircraft 210 based on relative distances between the UE 115-a and the respective aircraft 210. For example, the UE 115-a may use the information for the respective aircraft 210 (e.g., the respective routes, locations, flight times) to determine the respective distances and may select the aircraft 210 that is closest to the UE 115-a.

In response to receiving the emergency message 230-a, the aircraft 210-a may relay the emergency message 230-a to the base station 105-a. In some examples, the aircraft 210-a may relay the emergency message 230-a directly to the base station 105-a. For example, the aircraft 210-a may transmit an emergency message 230-b corresponding to the emergency message 230-a directly to the base station 105-a. In some examples, the aircraft 210-a may directly relay the emergency message 230-a to the base station 105-a based on being located within the coverage area 270.

In some examples, the aircraft 210-a may relay the emergency message 230-a indirectly to the base station 105-a. For example, the aircraft 210-a may relay the emergency message 230-a via one or more other aircraft 210. For instance, the aircraft 210-a may transmit an emergency message 230-c corresponding to the emergency message 230-a to the aircraft 210-b, and the aircraft 210-b may transmit an emergency message 230-d corresponding to emergency message 230-a to the base station 105-a (e.g., based on being located within the coverage area 270). Alternatively, the aircraft 210-a may relay the emergency message 230-a via the NTN node 205. For example, the aircraft 210-a may transmit an emergency message 230-e corresponding to the emergency message 230-a to the NTN node 205, and the NTN node 205 may transmit an emergency message 230-f corresponding to the emergency message 230-a to the base station 105-a. In some examples, the aircraft 210-a may indirectly relay the emergency message 230-a if the aircraft 210-a is located outside of the coverage area 270.

The aircraft 210-a may report whether it is capable of relaying the emergency message 230-a to the base station 105-a. For example, the aircraft 210-a may transmit a capability message 250 indicating that the aircraft 210-a is capable of relaying the emergency message 230-a. The relaying of the emergency message 230-a may be configured based on the capability message 250. For example, aircraft information 220 for the aircraft 210-a may be communicated between the wireless devices of the wireless communications system 200 based on the aircraft 210-a being capable of relaying the emergency message 230-a. As a result, the aircraft 210-a may receive the emergency message 230-a from the UE 115-a in accordance with the aircraft information 220-a and relay the emergency message 230-a to the base station 105-a. In some examples, the aircraft 210-a may report its relaying capability to a network via the NTN node 205 or the base station 105-a. For example, the aircraft 210-a may transmit a capability message 250-a to the NTN node 205, and the NTN node 205 may forward the reported relaying capability of the aircraft 210-a to the network. Alternatively, the aircraft 210-a may transmit a capability message 250-b to the base station 105-a, and the base station 105-a may forward the reported relaying capability of the aircraft 210-a to the network.

The aircraft 210-a may be enabled to relay the emergency message 230-a. For example, the aircraft 210-a may be configured to enable relaying operations based on a location of the aircraft 210-a satisfying a condition configured by the base station 105-a or the NTN node 205. For instance, the aircraft 210-a may enable transmission of the capability message 250, transmission of aircraft information 220 for the aircraft 210-a, performance of the RACH procedure, reception of the emergency message 230-a, relaying of the emergency message 230-a, or a combination thereof, when the location of the aircraft 210-a satisfies the condition. In some examples, the location of the aircraft 210-a satisfying the condition may include a GNSS position of the aircraft 210-a being within a geographic area configured by the base station 105-a or the NTN node 205. In other words, if the aircraft 210-a is traveling within the geographic area, the aircraft 210-a may enable the relaying operations.

Additionally or alternatively, the NTN node 205 or the base station 105-a may trigger the aircraft 210-a to enable the relaying operations. For example, the NTN node 205 may transmit an enablement indication 260-a to the aircraft 210-a that causes (e.g., triggers, indicates for) the aircraft 210-a to enable the relaying operations. Alternatively, the base station 105-a may transmit an enablement indication 260-b to the aircraft 210-a the causes (e.g., triggers, indicates for) the aircraft 210-a to enable the relaying operations. In response to receiving an enablement indication 260, the aircraft 210-a may enable the relaying operations. In some examples, the NTN node 205 or the base station 105-a may transmit an enablement indication 260 based on the location of the aircraft 210-a satisfying the condition. In some examples, the NTN node 205 or the base station 105-a may transmit an enablement indication 260 based on the aircraft 210-a indicating it is capable of relaying the emergency message 230-a (e.g., via the capability message 250).

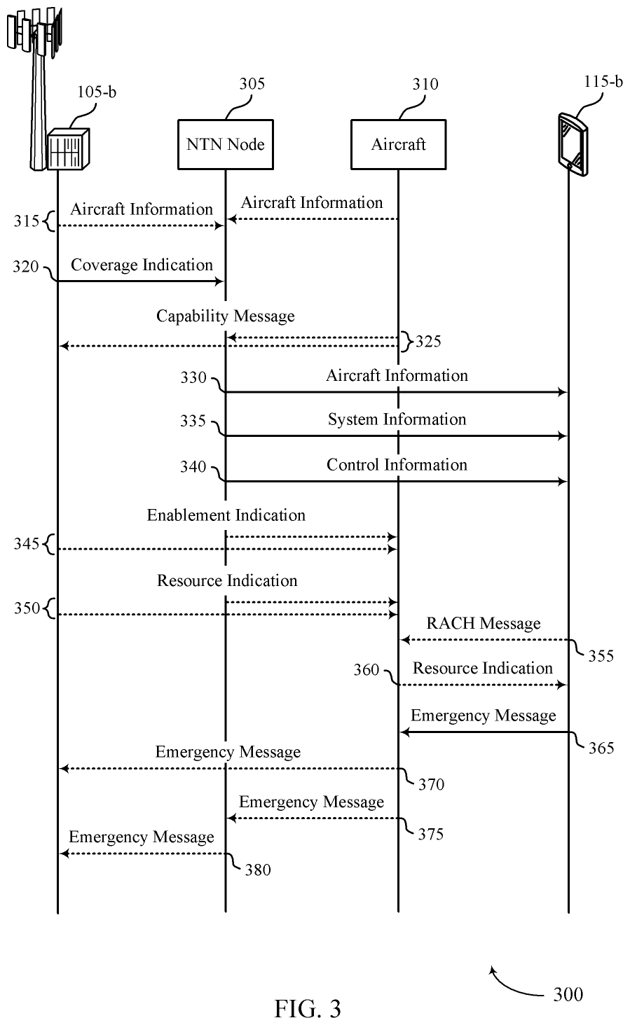

FIG. 3 illustrates an example of a process flow 300 that supports techniques for aircraft relaying in accordance with aspects of the present disclosure. The process flow 300 may implement or may be implemented by aspects of the wireless communications systems 100 and 200 as described with reference to FIGS. 1 and 2, respectively. For example, the process flow 300 may be implemented by a base station 105-b, a UE 115-b, an NTN node 305, and an aircraft 310 to support the aircraft relaying of emergency messages while the UE 115-b is located outside of a coverage area of the base station 105-b.

The base station 105-b, the UE 115-b, the NTN node 305, and the aircraft 310 may each be examples of the corresponding devices as respectively described herein, including with reference to FIGS. 1 and 2. The base station 105-b may be an example of a terrestrial base station described herein.

In the following description of the process flow 300, the operations may be performed in different orders or at different times. Some operations also may be omitted from the process flow 300, and other operations may be added to the process flow 300. Further, although some operations or signaling may be shown to occur at different times for discussion purposes, these operations may actually occur at the same time.

At 315, the NTN node 305 may receive aircraft information for the aircraft 310. For example, the aircraft 310 may transmit the aircraft information to the NTN node 305 (e.g., via an aircraft-to-satellite communication link). Alternatively, the base station 105-b may transmit the aircraft information to the NTN node 305. In some examples, the base station 105 may receive the aircraft information from the aircraft 310 and may relay the aircraft information to the NTN node 305.

The aircraft information may enable the communication of emergency messages from the UE 115-b to the aircraft 310 while the UE 115-b is located outside of a coverage area of the base station 105-b. For example, the aircraft information may indicate a route of the aircraft 310, a flight time of the aircraft 310, a location of the aircraft 310, timing advance information associated with transmitting an emergency message to the aircraft 310, a RACH preamble format, a first resource for transmitting a RACH preamble to the aircraft 310, a preserved resource for transmitting the emergency message to the aircraft 310, or a combination thereof. In some examples, the aircraft information may be an example of aircraft information 220 described with reference to FIG. 2.

At 320, the base station 105-b may transmit a coverage indication to the NTN node 305. In some examples, the coverage indication may indicate a coverage area of the base station 105-b (e.g., a coverage area 110 or a coverage area 270 described with reference to FIGS. 1 and 2, respectively), which the NTN node 305 may use to determine an area (e.g., a geographic area, a geographic boundary) that is outside of the coverage area of the base station 105-b. In some other examples, the coverage indication may indicate the area that is outside of the coverage area. In some examples, the coverage indication may be an example of a coverage indication 265 described with reference to FIG. 2.

At 325, the aircraft 310 may transmit a capability message to the NTN node 305, the base station 105-b, or both. The capability message may indicate whether the aircraft 310 is capable of relaying emergency messages to the base station 105-b. For example, the capability message may indicate that the aircraft 310 is capable of relaying (e.g., transmitting, forwarding) the emergency message received from the UE 115-b to the base station 105-b.

At 330, the NTN node 305 may transmit the aircraft information for the aircraft 310 to the UE 115-b. In some examples, the NTN node 305 may broadcast the aircraft information to the area that is outside of the coverage area. The UE 115-b may be located in the area that is outside of the coverage area and may thus receive the broadcasted aircraft information from the NTN node 305.

At 335, the NTN node 305 may transmit system information to the UE 115-b. In some examples, the NTN node 305 may broadcast the system information to the area that is outside of the coverage area, and the UE 115-a may receive the broadcasted system information based on being located in the area that is outside of the coverage area. The system information may indicate that the NTN node 305 is a satellite. In some examples, the system information may be an example of system information 225 described with reference to FIG. 2.

At 340, the NTN node 305 may transmit control information to the UE 115-b. In some examples, the NTN node 305 may broadcast the control to the area that is outside of the coverage area, and the UE 115-a may receive the broadcasted control information based on being located in the area that is outside of the coverage area. In some cases, the NTN node 305 may transmit the control information in a MIB, a SIB, (e.g., a SIB1 or some other type of SIB), or a combination thereof. In some examples, the control information may indicate that a timing of communications between the NTN node 305 and the UE 115-b is asynchronous with a timing of communications between the aircraft 310 and the UE 115-b. In some examples, the control information may indicate for the UE 115-b to transmit the emergency message to the aircraft 310 in the preserved resource. In some examples, the control information may indicate for the UE 115-b to perform a RACH procedure with the aircraft 310 rather than the NTN node 305 (e.g., transmit the RACH preamble to the aircraft 310 using the first resource). In some examples, the control information may be an example of control information 245 described with reference to FIG. 2.

At 345, the aircraft 310 may receive an enablement indication. The enablement indication may indicate for (e.g., trigger) the aircraft 310 to enable relaying operations, such as enabling reception of the emergency message from the UE 115-b relaying the emergency message to the base station 105-b, among other relaying operations described herein. In some examples, the aircraft 310 may receive the enablement indication from the NTN node 305. In some other examples, the base station 105-b may transmit the enablement indication to the aircraft 310. In some examples, the enablement indication may be an example of an enablement indication 260 described with reference to FIG. 2.

At 350, the aircraft 310 may receive a first resource indication. In some examples, the first resource indication may indicate the preserved resource over which the UE 115-b may transmit the emergency message to the aircraft 310. In some other examples, the first resource indication may indicate the first resource over which the UE 115-b may transmit the RACH preamble as part of the RACH procedure. In response to receiving the first resource indication, the aircraft 310 may monitor the preserved resource for the emergency message or the first resource for the RACH preamble. In some cases, the base station 105-b may transmit the first resource indication to the aircraft 310. In some other cases, the NTN node 305 may transmit the first resource indication to the aircraft 310. In some examples, the first resource indication may be an example of a resource indication 255 described with reference to FIG. 2.

At 355, the UE 115-b may transmit a RACH message to the aircraft 310. For example, the UE 115-b may transmit, to the aircraft 310 using the first resource, the RACH preamble having the format indicated by the aircraft information. Transmitting the RACH preamble may initiate the RACH procedure between the UE 115-b and the aircraft 310 to establish a communication link between the UE 115-b and the aircraft 310. In some examples, the UE 115-b may transmit the RACH message in response to the control information indicating for the UE 115-b to perform the RACH procedure with the aircraft 310. In some examples, the RACH message may be an example of a RACH message 235 220 described with reference to FIG. 2.

At 360, the aircraft 310 may transmit a second resource indication to the UE 115-b. For example, based on the RACH procedure, the aircraft 310 may transmit the second resource indication to indicate a second resource for the UE 115-b to use to transmit the emergency message to the aircraft 310. In some examples, the second resource indication may be an example of a resource indication 240 described with reference to FIG. 2.

At 365, the UE 115-b may transmit the emergency message to the aircraft 310. In some examples, the UE 115-b may transmit the emergency message to the aircraft 310 using the preserved resource, for example, if the control information indicates for the UE 115-b to use the preserved sidelink resource. In some other examples, the UE 115-b may transmit the emergency message to the aircraft 310 using the second resource, for example, based on performing the RACH procedure with the aircraft 310.

In some examples, at 370, the aircraft 310 may transmit (e.g., relay, forward) the emergency message to the base station 105-b. In some cases, the aircraft 310 may transmit the emergency message directly to the base station 105-b (e.g., without transmitting the emergency message to any intervening wireless communication devices), for example, based on traveling within the coverage area of the base station 105-b.

In some other examples, at 375, the aircraft 310 may relay the emergency message to the base station 105-b via one or more intervening wireless communication devices (e.g., based on traveling outside of the coverage area of the base station 105-b). For example, the aircraft 310 may transmit the emergency message to the NTN node 305, and, at 380, the NTN node 305 may transmit (e.g., relay, forward) the emergency message to the base station 105-b (e.g., directly, via one or more other aircraft 310). Alternatively, the aircraft 310 may transmit the emergency message to a second aircraft 310 (not shown), and the second aircraft 310 may transmit (e.g., relay forward) the emergency message to the base station 105-b (e.g., directly, via one or more additional aircraft 310, via the NTN node 305).

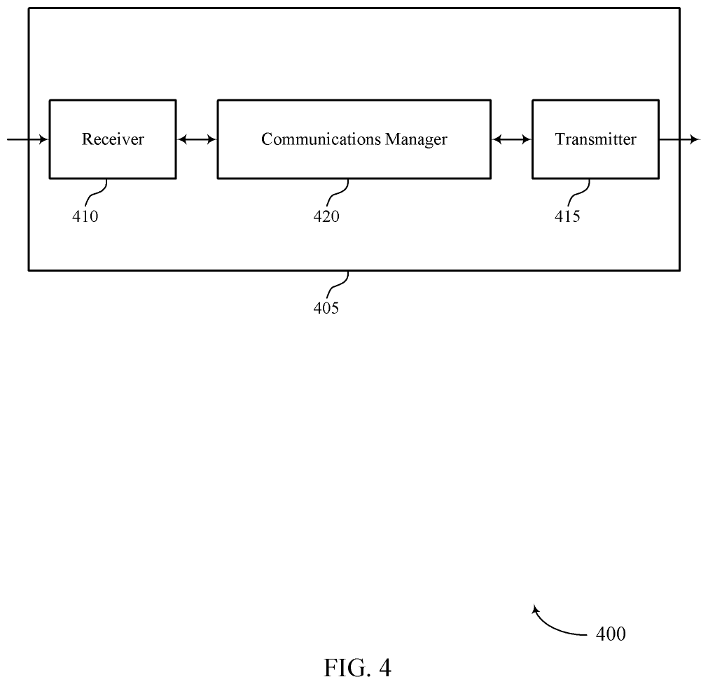

FIG. 4 shows a block diagram 400 of a device 405 that supports techniques for aircraft relaying in accordance with aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for aircraft relaying). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for aircraft relaying). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of techniques for aircraft relaying as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

The communications manager 420 may support wireless communication at a UE in accordance with examples as disclosed herein. For example, the communications manager 420 may be configured as or otherwise support a means for receiving, from a network node of an NTN, a first message including aircraft information for an aircraft and associated with a transmission of a second message, from the UE to the aircraft, including emergency information associated with the UE. The communications manager 420 may be configured as or otherwise support a means for transmitting, in response to being located outside of a coverage area of a terrestrial base station and based on the aircraft information, the second message including the emergency information to the aircraft for relaying to the terrestrial base station.

By including or configuring the communications manager 420 in accordance with examples as described herein, the device 405 (e.g., a processor controlling or otherwise coupled to the receiver 410, the transmitter 415, the communications manager 420, or a combination thereof) may support techniques for reduced power consumption and more efficient utilization of communication resources by supporting the communication of emergency messages (e.g., SOS messages) via aircraft.

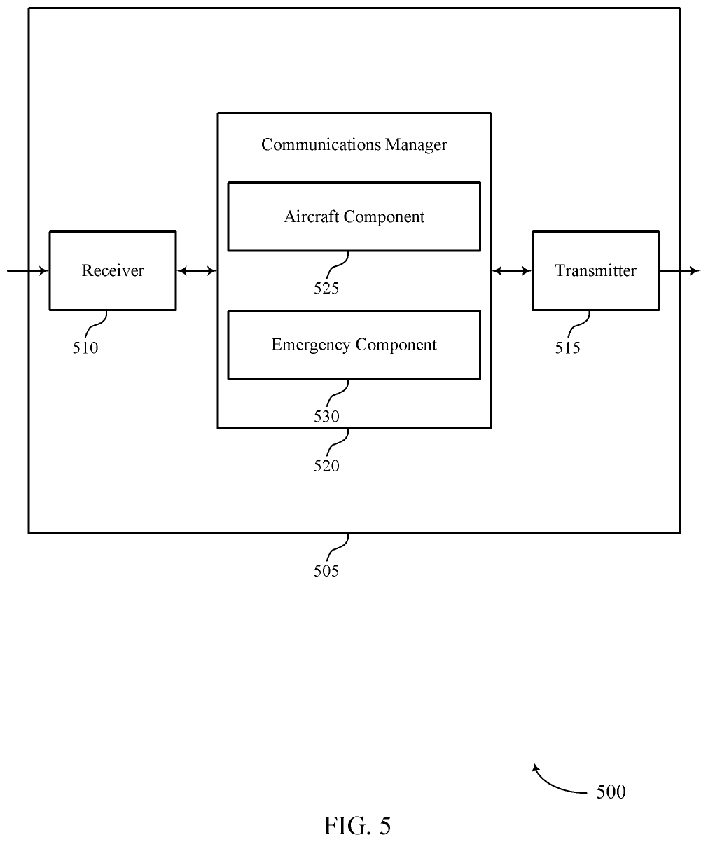

FIG. 5 shows a block diagram 500 of a device 505 that supports techniques for aircraft relaying in accordance with aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for aircraft relaying). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for aircraft relaying). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for aircraft relaying as described herein. For example, the communications manager 520 may include an aircraft component 525 an emergency component 530, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. The aircraft component 525 may be configured as or otherwise support a means for receiving, from a network node of an NTN, a first message including aircraft information for an aircraft and associated with a transmission of a second message, from the UE to the aircraft, including emergency information associated with the UE. The emergency component 530 may be configured as or otherwise support a means for transmitting, in response to being located outside of a coverage area of a terrestrial base station and based on the aircraft information, the second message including the emergency information to the aircraft for relaying to the terrestrial base station.

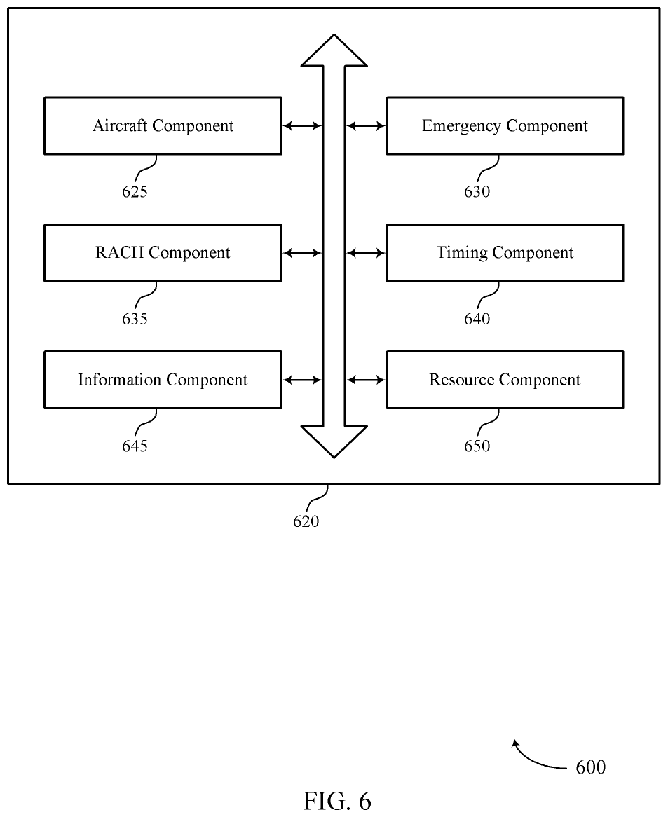

FIG. 6 shows a block diagram 600 of a communications manager 620 that supports techniques for aircraft relaying in accordance with aspects of the present disclosure. The communications manager 620 may be an example of aspects of a communications manager 420, a communications manager 520, or both, as described herein. The communications manager 620, or various components thereof, may be an example of means for performing various aspects of techniques for aircraft relaying as described herein. For example, the communications manager 620 may include an aircraft component 625, an emergency component 630, a RACH component 635, a timing component 640, an information component 645, a resource component 650, or any combination thereof. Each of these components may communicate, directly or indirectly, with one another (e.g., via one or more buses).

The communications manager 620 may support wireless communication at a UE in accordance with examples as disclosed herein. The aircraft component 625 may be configured as or otherwise support a means for receiving, from a network node of an NTN, a first message including aircraft information for an aircraft and associated with a transmission of a second message, from the UE to the aircraft, including emergency information associated with the UE. The emergency component 630 may be configured as or otherwise support a means for transmitting, in response to being located outside of a coverage area of a terrestrial base station and based on the aircraft information, the second message including the emergency information to the aircraft for relaying to the terrestrial base station.

In some examples, to support transmitting the second message including the emergency information, the emergency component 630 may be configured as or otherwise support a means for transmitting the second message including the emergency information using a resource indicated by the aircraft information.

In some examples, the resource component 650 may be configured as or otherwise support a means for receiving, from the network node of the NTN and based on being in an idle state or an inactive state, a third message indicating for the UE to transmit the second message including the emergency information using the resource indicated by the aircraft information, where transmitting the second message uses the resource.

In some examples, the aircraft information indicates a first resource for transmitting a RACH preamble to the aircraft and a format of the RACH preamble. In some examples, the RACH component 635 may be configured as or otherwise support a means for transmitting, to the aircraft, a third message including the RACH preamble as part of a RACH procedure with the aircraft. In some examples, the RACH component 635 may be configured as or otherwise support a means for receiving, from the aircraft and based on the RACH procedure, an indication of a second resource for transmitting the second message including the emergency information, where the second message is transmitted using the second resource.

In some examples, the RACH component 635 may be configured as or otherwise support a means for receiving, from the network node of the NTN, a second indication to initiate the RACH procedure with the aircraft, where the third message including the RACH preamble is transmitted to the aircraft based on receiving the second indication.

In some examples, the RACH component 635 may be configured as or otherwise support a means for receiving, from the network node of the NTN, a second indication to refrain from initiating the RACH procedure with the network node of the NTN, where the third message including the RACH preamble is transmitted to the aircraft based on receiving the second indication.

In some examples, the aircraft component 625 may be configured as or otherwise support a means for monitoring for the first message including the aircraft information from the network node of the NTN based on being located outside of the coverage area of the terrestrial base station, where the first message including the aircraft information is received while the UE is located outside of the coverage area of the terrestrial base station based on the monitoring.

In some examples, the timing component 640 may be configured as or otherwise support a means for receiving, from the network node of the NTN, an indication that a first timing associated with transmitting the second message to the aircraft is asynchronous with a second timing associated with receiving the first message from the network node of the NTN, where transmitting the second message is based on receiving the indication.

In some examples, the aircraft information indicates a route of the aircraft, a flight time associated with the aircraft, a location of the aircraft, timing advance information associated with transmitting the second message including the emergency information, or a combination thereof.

In some examples, the information component 645 may be configured as or otherwise support a means for receiving, from the network node of the NTN, system information indicating that the first message including the aircraft information and control signaling are received from the network node of the NTN, where the network node of the NTN includes a satellite.

In some examples, a resource used to transmit the second message including the emergency information is an uplink resource or a sidelink resource based on a configuration of the aircraft.

In some examples, the first message includes second aircraft information for a second aircraft, and the aircraft component 625 may be configured as or otherwise support a means for selecting the aircraft from at least the aircraft and the second aircraft to which to transmit the second message including the emergency information based on the aircraft information and the second aircraft information.

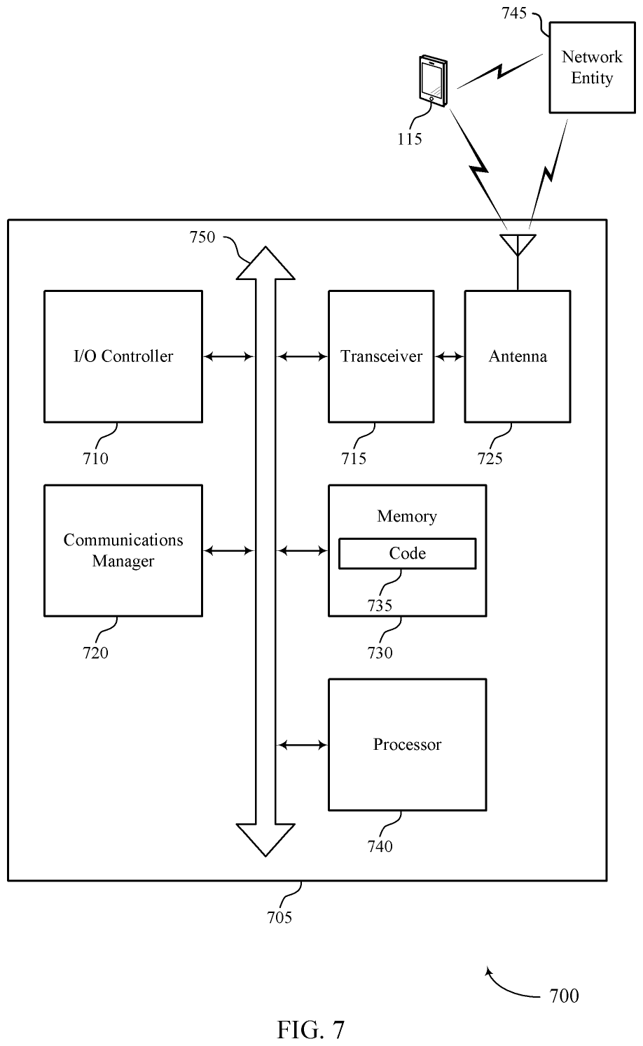

FIG. 7 shows a diagram of a system 700 including a device 705 that supports techniques for aircraft relaying in accordance with aspects of the present disclosure. The device 705 may be an example of or include the components of a device 405, a device 505, or a UE 115 as described herein. The device 705 may communicate wirelessly with one or more network entities 745 (e.g., which may be examples of a base station 105, an NTN node, or an aircraft described herein), UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 750).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting techniques for aircraft relaying). For example, the device 705 or a component of the device 705 may include a processor 740 and memory 730 coupled to the processor 740, the processor 740 and memory 730 configured to perform various functions described herein.

The communications manager 720 may support wireless communication at a UE in accordance with examples as disclosed herein. For example, the communications manager 720 may be configured as or otherwise support a means for receiving, from a network node of an NTN, a first message including aircraft information for an aircraft and associated with a transmission of a second message, from the UE to the aircraft, including emergency information associated with the UE. The communications manager 720 may be configured as or otherwise support a means for transmitting, in response to being located outside of a coverage area of a terrestrial base station and based on the aircraft information, the second message including the emergency information to the aircraft for relaying to the terrestrial base station.

By including or configuring the communications manager 720 in accordance with examples as described herein, the device 705 may support techniques for improved coverage (e.g., expanded cellular coverage for emergency communications), reliability, latency, data rates, power consumption, resource utilization efficiency, coordination between devices, and longer battery life, among other benefits.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of techniques for aircraft relaying as described herein, or the processor 740 and the memory 730 may be otherwise configured to perform or support such operations.

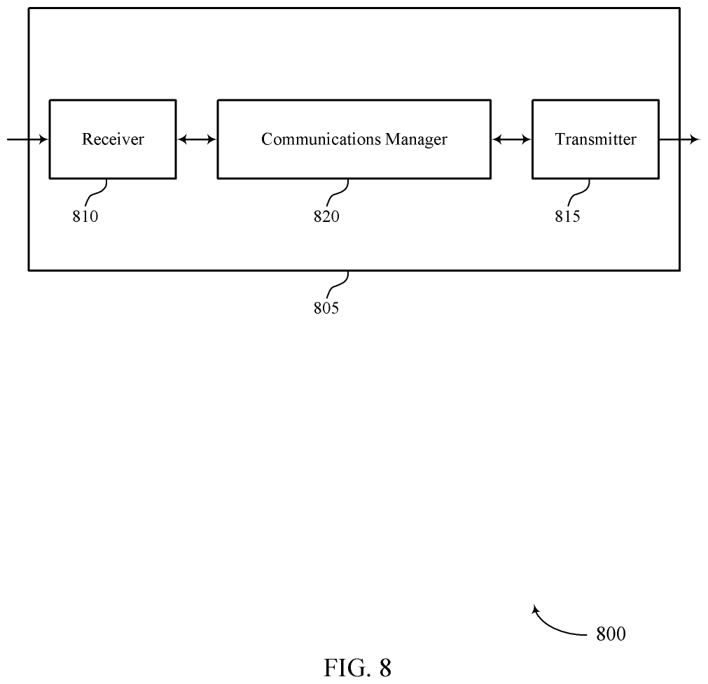

FIG. 8 shows a block diagram 800 of a device 805 that supports techniques for aircraft relaying in accordance with aspects of the present disclosure. The device 805 may be an example of aspects of an aircraft as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for aircraft relaying). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for aircraft relaying). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of techniques for aircraft relaying as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at an aircraft in accordance with examples as disclosed herein. For example, the communications manager 820 may be configured as or otherwise support a means for receiving, from a UE, a first message including emergency information associated with the UE, the first message including the emergency information received over a resource allocated based on a set of parameters associated with the aircraft. The communications manager 820 may be configured as or otherwise support a means for transmitting, to a terrestrial base station, a second message including the emergency information based on receiving the first message.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for reduced power consumption and more efficient utilization of communication resources by supporting the communication of emergency messages (e.g., SOS messages) via aircraft.

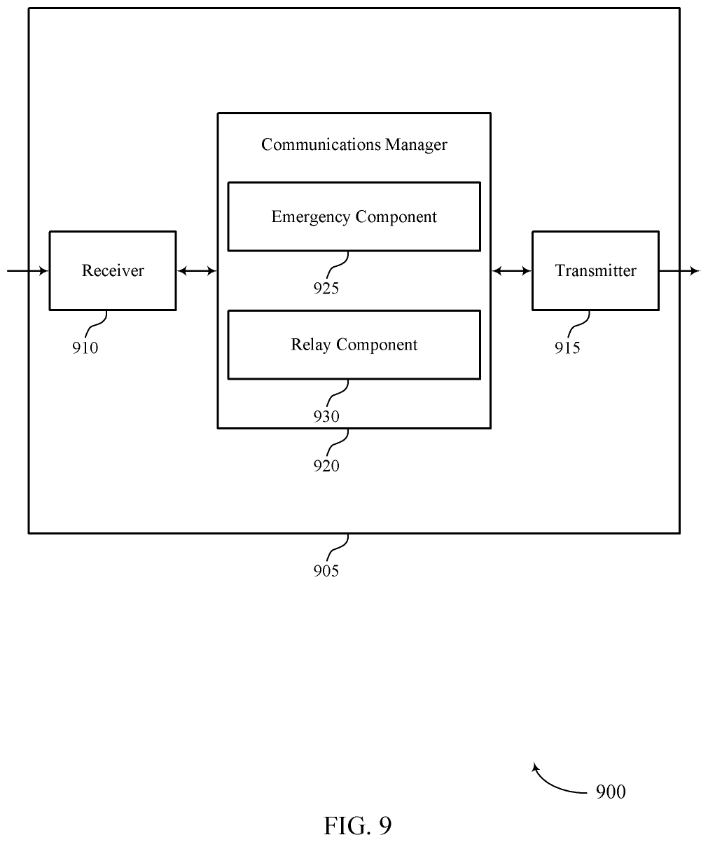

FIG. 9 shows a block diagram 900 of a device 905 that supports techniques for aircraft relaying in accordance with aspects of the present disclosure. The device 905 may be an example of aspects of a device 805 or an aircraft as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for aircraft relaying). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for aircraft relaying). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for aircraft relaying as described herein. For example, the communications manager 920 may include an emergency component 925 a relay component 930, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at an aircraft in accordance with examples as disclosed herein. The emergency component 925 may be configured as or otherwise support a means for receiving, from a UE, a first message including emergency information associated with the UE, the first message including the emergency information received over a resource allocated based on a set of parameters associated with the aircraft. The relay component 930 may be configured as or otherwise support a means for transmitting, to a terrestrial base station, a second message including the emergency information based on receiving the first message.

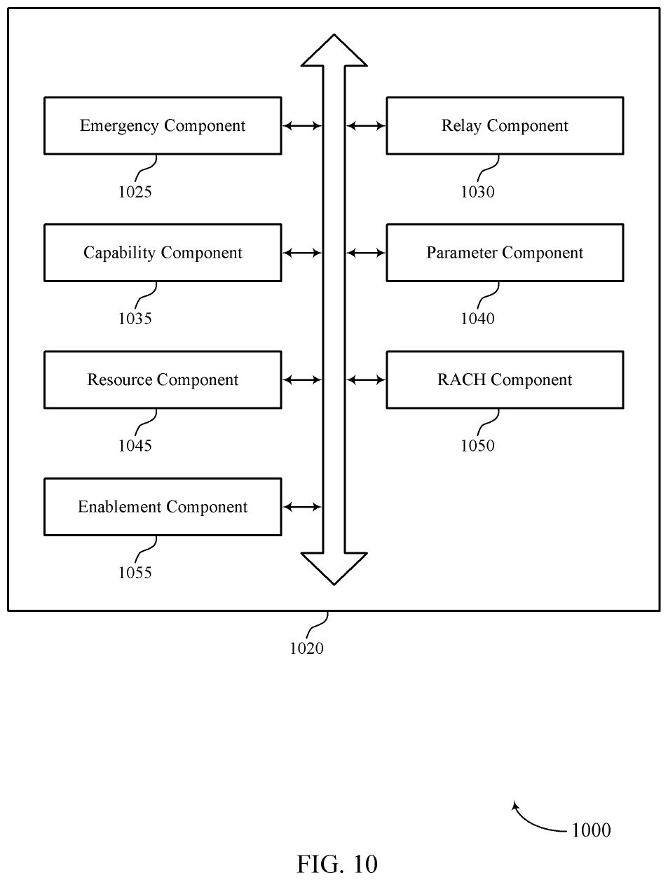

FIG. 10 shows a block diagram 1000 of a communications manager 1020 that supports techniques for aircraft relaying in accordance with aspects of the present disclosure. The communications manager 1020 may be an example of aspects of a communications manager 820, a communications manager 920, or both, as described herein. The communications manager 1020, or various components thereof, may be an example of means for performing various aspects of techniques for aircraft relaying as described herein. For example, the communications manager 1020 may include an emergency component 1025, a relay component 1030, a capability component 1035, a parameter component 1040, a resource component 1045, a RACH component 1050, an enablement component 1055, or any combination thereof. Each of these components may communicate, directly or indirectly, with one another (e.g., via one or more buses).

The communications manager 1020 may support wireless communication at an aircraft in accordance with examples as disclosed herein. The emergency component 1025 may be configured as or otherwise support a means for receiving, from a UE, a first message including emergency information associated with the UE, the first message including the emergency information received over a resource allocated based on a set of parameters associated with the aircraft. The relay component 1030 may be configured as or otherwise support a means for transmitting, to a terrestrial base station, a second message including the emergency information based on receiving the first message.

In some examples, the capability component 1035 may be configured as or otherwise support a means for transmitting, to the terrestrial base station or a network node of an NTN, a third message indicating a capability of the aircraft to relay the second message including the emergency information to the terrestrial base station, where receiving the first message is based on transmitting the third message.

In some examples, the parameter component 1040 may be configured as or otherwise support a means for transmitting, to the terrestrial base station or a network node of an NTN, a third message indicating the set of parameters associated with the aircraft, the set of parameters associated with the aircraft including a route of the aircraft, a flight time associated with the aircraft, a location of the aircraft, or a combination thereof, where receiving the first message is based on transmitting the third message.

In some examples, the resource component 1045 may be configured as or otherwise support a means for receiving, from the terrestrial base station or a network node of an NTN, an indication of the resource allocated for the first message including the emergency information. In some examples, the emergency component 1025 may be configured as or otherwise support a means for monitoring the resource for the first message including the emergency information based on receiving the indication, where the first message including the emergency information is received over the resource based on the monitoring.

In some examples, the RACH component 1050 may be configured as or otherwise support a means for receiving, from the terrestrial base station or a network node of an NTN, a first indication of a first resource for receiving a RACH preamble from the UE and a format of the RACH preamble. In some examples, the RACH component 1050 may be configured as or otherwise support a means for monitoring, based on receiving the first indication, the first resource for the RACH preamble as part of a RACH procedure with the UE, where the resource is allocated for the first message including the emergency information based on the RACH procedure.

In some examples, the RACH component 1050 may be configured as or otherwise support a means for receiving, from the UE and based on the monitoring, a third message including the RACH preamble as part of the RACH procedure with the UE. In some examples, the RACH component 1050 may be configured as or otherwise support a means for transmitting, to the UE and based on performing the RACH procedure, a second indication of the resource allocated for the first message including the emergency information, where the first message including the emergency information is received over the resource based on transmitting the second indication.

In some examples, the enablement component 1055 may be configured as or otherwise support a means for receiving, from the terrestrial base station or a network node of an NTN, an indication to enable reception of the first message including the emergency information from the UE and transmission of the second message including the emergency information to the terrestrial base station.

In some examples, the enablement component 1055 may be configured as or otherwise support a means for enabling reception of the first message including the emergency information from the UE and transmission of the second message including the emergency information to the terrestrial base station based on a location of the aircraft satisfying a condition configured by the terrestrial base station or a network node of an NTN.

In some examples, to support transmitting the second message including the emergency information to the terrestrial base station, the relay component 1030 may be configured as or otherwise support a means for transmitting the second message including the emergency information to a second aircraft or a network node of an NTN for relaying the second message including the emergency information to the terrestrial base station.

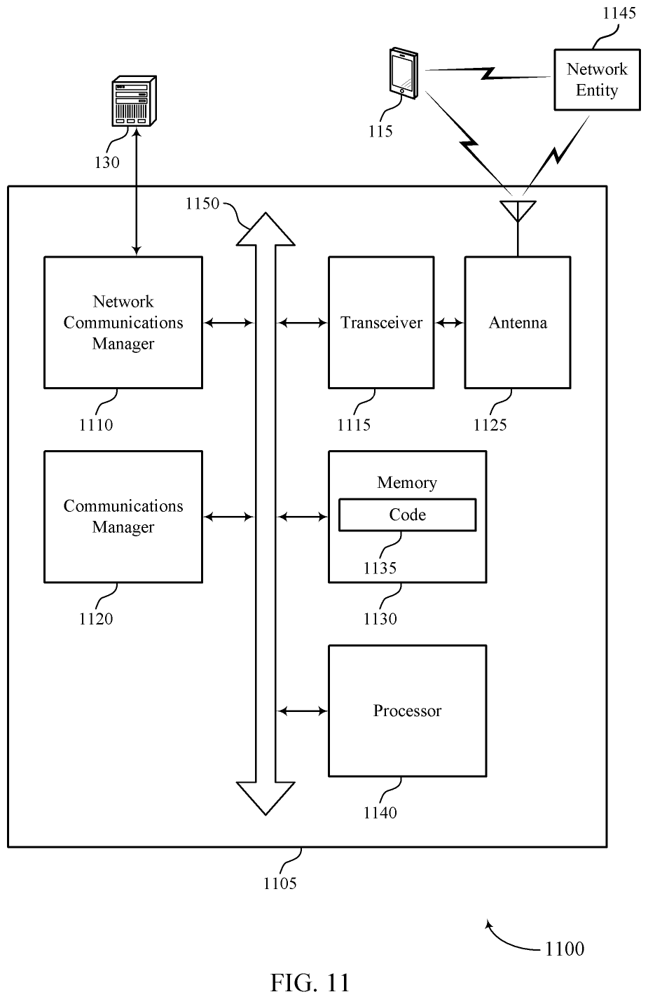

FIG. 11 shows a diagram of a system 1100 including a device 1105 that supports techniques for aircraft relaying in accordance with aspects of the present disclosure. The device 1105 may be an example of or include the components of a device 805, a device 905, or an aircraft as described herein. The device 1105 may communicate wirelessly with one or more network entities 1145 (e.g., which may be examples of a base station 105, an NTN node, or an aircraft described herein), UEs 115, or any combination thereof. The device 1105 may include components for bi-directional voice and data communications including components for transmitting and receiving communications, such as a communications manager 1120, a network communications manager 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1150).

The network communications manager 1110 may manage communications with a core network 130 (e.g., via one or more wireless backhaul links). For example, the network communications manager 1110 may manage the transfer of data communications for client devices, such as one or more UEs 115.

In some cases, the device 1105 may include a single antenna 1125. However, in some other cases the device 1105 may have more than one antenna 1125, which may be capable of concurrently transmitting or receiving multiple wireless transmissions. The transceiver 1115 may communicate bi-directionally, via the one or more antennas 1125, using wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include RAM and ROM. The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a BIOS which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for aircraft relaying). For example, the device 1105 or a component of the device 1105 may include a processor 1140 and memory 1130 coupled to the processor 1140, the processor 1140 and memory 1130 configured to perform various functions described herein.

The communications manager 1120 may support wireless communication at an aircraft in accordance with examples as disclosed herein. For example, the communications manager 1120 may be configured as or otherwise support a means for receiving, from a UE, a first message including emergency information associated with the UE, the first message including the emergency information received over a resource allocated based on a set of parameters associated with the aircraft. The communications manager 1120 may be configured as or otherwise support a means for transmitting, to a terrestrial base station, a second message including the emergency information based on receiving the first message.

By including or configuring the communications manager 1120 in accordance with examples as described herein, the device 1105 may support techniques for improved coverage (e.g., expanded cellular coverage for emergency communications), reliability, latency, data rates, power consumption, resource utilization efficiency, coordination between devices, and longer battery life, among other benefits.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of techniques for aircraft relaying as described herein, or the processor 1140 and the memory 1130 may be otherwise configured to perform or support such operations.

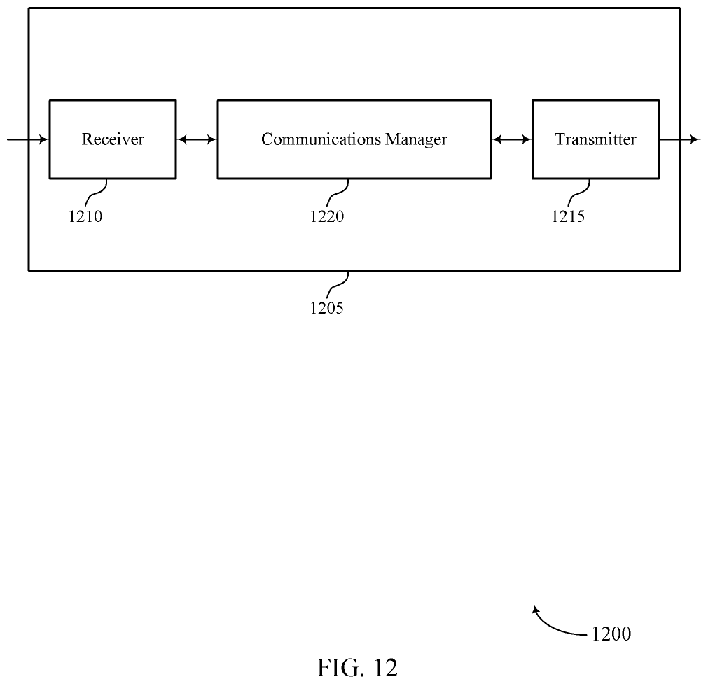

FIG. 12 shows a block diagram 1200 of a device 1205 that supports techniques for aircraft relaying in accordance with aspects of the present disclosure. The device 1205 may be an example of aspects of a network node of an NTN as described herein (e.g., an NTN node, a satellite). The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to techniques for aircraft relaying). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to techniques for aircraft relaying). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations thereof or various components thereof may be examples of means for performing various aspects of techniques for aircraft relaying as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1220 may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communication at a network node of an NTN in accordance with examples as disclosed herein. For example, the communications manager 1220 may be configured as or otherwise support a means for receiving, from a terrestrial base station or an aircraft, a first message including aircraft information for the aircraft and associated with a transmission of a second message, from a UE to the aircraft, including emergency information associated with the UE. The communications manager 1220 may be configured as or otherwise support a means for transmitting, to the UE, a third message including the aircraft information based on receiving the first message including the aircraft information.

By including or configuring the communications manager 1220 in accordance with examples as described herein, the device 1205 (e.g., a processor controlling or otherwise coupled to the receiver 1210, the transmitter 1215, the communications manager 1220, or a combination thereof) may support techniques for reduced power consumption and more efficient utilization of communication resources by enabling the communication of emergency messages (e.g., SOS messages) via aircraft.

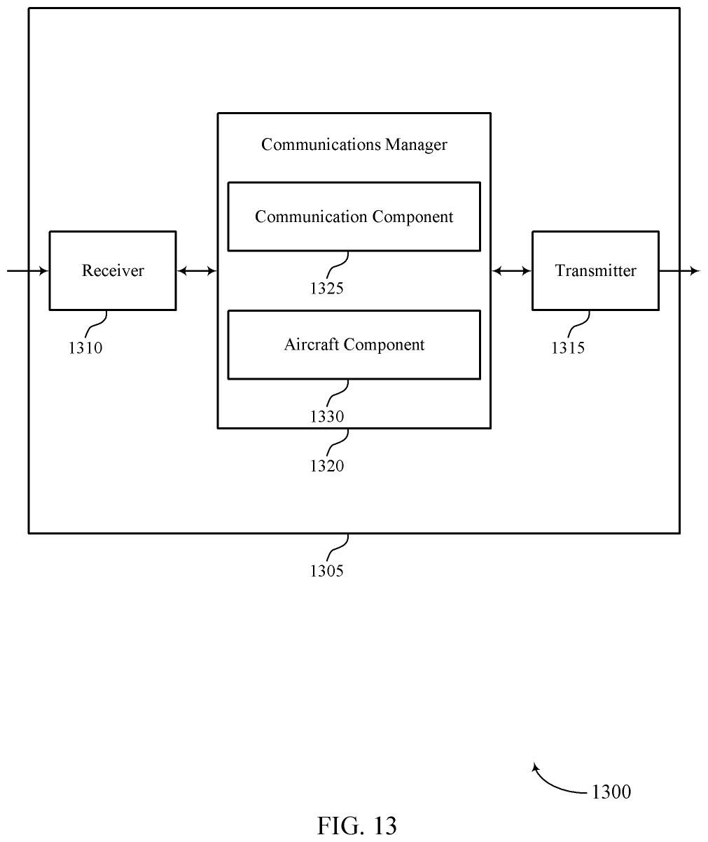

FIG. 13 shows a block diagram 1300 of a device 1305 that supports techniques for aircraft relaying in accordance with aspects of the present disclosure. The device 1305 may be an example of aspects of a device 1205 or a network node of an NTN as described herein (e.g., an NTN node, a satellite). The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to techniques for aircraft relaying). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to techniques for aircraft relaying). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of techniques for aircraft relaying as described herein. For example, the communications manager 1320 may include a communication component 1325 an aircraft component 1330, or any combination thereof. The communications manager 1320 may be an example of aspects of a communications manager 1220 as described herein. In some examples, the communications manager 1320, or various components thereof, may be configured to perform various operations (e.g., receiving, monitoring, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to receive information, transmit information, or perform various other operations as described herein.

The communications manager 1320 may support wireless communication at a network node of an NTN in accordance with examples as disclosed herein. The communication component 1325 may be configured as or otherwise support a means for receiving, from a terrestrial base station or an aircraft, a first message including aircraft information for the aircraft and associated with a transmission of a second message, from a UE to the aircraft, including emergency information associated with the UE. The aircraft component 1330 may be configured as or otherwise support a means for transmitting, to the UE, a third message including the aircraft information based on receiving the first message including the aircraft information.

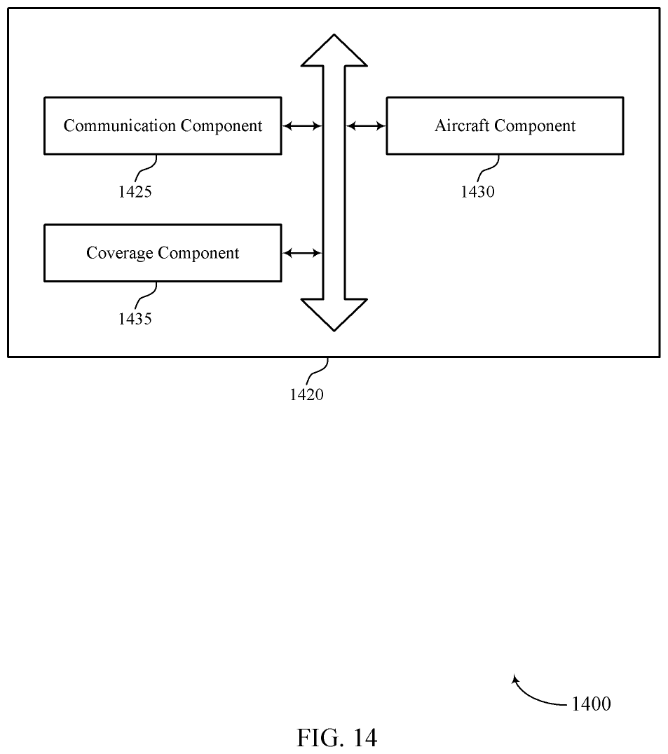

FIG. 14 shows a block diagram 1400 of a communications manager 1420 that supports techniques for aircraft relaying in accordance with aspects of the present disclosure. The communications manager 1420 may be an example of aspects of a communications manager 1220, a communications manager 1320, or both, as described herein. The communications manager 1420, or various components thereof, may be an example of means for performing various aspects of techniques for aircraft relaying as described herein. For example, the communications manager 1420 may include a communication component 1425, an aircraft component 1430, a coverage component 1435, or any combination thereof. Each of these components may communicate, directly or indirectly, with one another (e.g., via one or more buses).

The communications manager 1420 may support wireless communication at a network node of an NTN in accordance with examples as disclosed herein. The communication component 1425 may be configured as or otherwise support a means for receiving, from a terrestrial base station or an aircraft, a first message including aircraft information for the aircraft and associated with a transmission of a second message, from a UE to the aircraft, including emergency information associated with the UE. The aircraft component 1430 may be configured as or otherwise support a means for transmitting, to the UE, a third message including the aircraft information based on receiving the first message including the aircraft information.

In some examples, the coverage component 1435 may be configured as or otherwise support a means for receiving, from the terrestrial base station, a fourth message including an indication of an area that is outside of a coverage area of the terrestrial base station, where transmitting the third message including the aircraft information to the UE is based on receiving the fourth message.

In some examples, to support transmitting the third message including the aircraft information, the aircraft component 1430 may be configured as or otherwise support a means for broadcasting the third message including the aircraft information to one or more UEs located in an area that is outside of a coverage area of the terrestrial base station, the one or more UEs including the UE.

In some examples, the aircraft information indicates a first resource for the UE to use to transmit the second message including the emergency information to the aircraft, a second resource for the UE to use to transmit a RACH preamble to the aircraft, a format of the RACH preamble, a route of the aircraft, a flight time associated with the aircraft, a location of the aircraft, timing advance information associated with transmitting the second message including the emergency information to the aircraft, or a combination thereof.

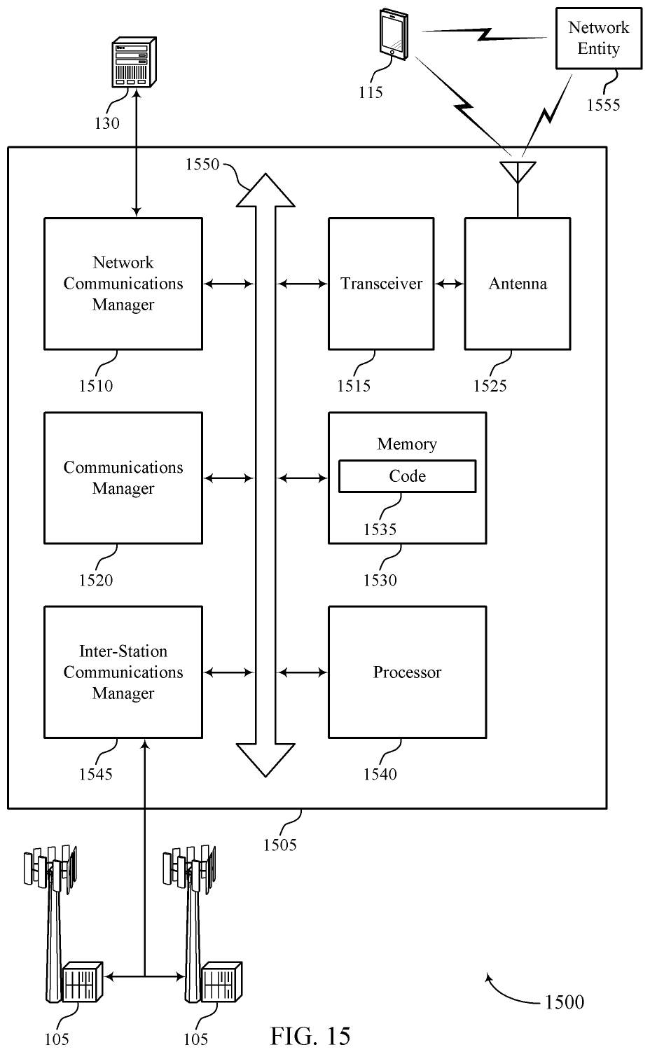

FIG. 15 shows a diagram of a system 1500 including a device 1505 that supports techniques for aircraft relaying in accordance with aspects of the present disclosure. The device 1505 may be an example of or include the components of a device 1205, a device 1305, or a network node of an NTN as described herein (e.g., an NTN node, a satellite). The device 1505 may communicate wirelessly with one or more terrestrial base stations 105, UEs 115, network entities 1555 (e.g., which may be examples of an NTN node or an aircraft described herein) or any combination thereof. The device 1505 may include components for bi-directional voice and data communications including components for transmitting and receiving communications, such as a communications manager 1520, a network communications manager 1510, a transceiver 1515, an antenna 1525, a memory 1530, code 1535, a processor 1540, and an inter-station communications manager 1545. These components may be in electronic communication or otherwise coupled (e.g., operatively, communicatively, functionally, electronically, electrically) via one or more buses (e.g., a bus 1550).

The network communications manager 1510 may manage communications with a core network 130 (e.g., via one or more wireless backhaul links). For example, the network communications manager 1510 may manage the transfer of data communications for client devices, such as one or more UEs 115.

In some cases, the device 1505 may include a single antenna 1525. However, in some other cases the device 1505 may have more than one antenna 1525, which may be capable of concurrently transmitting or receiving multiple wireless transmissions. The transceiver 1515 may communicate bi-directionally, via the one or more antennas 1525, using wireless links as described herein. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The memory 1530 may include RAM and ROM. The memory 1530 may store computer-readable, computer-executable code 1535 including instructions that, when executed by the processor 1540, cause the device 1505 to perform various functions described herein. The code 1535 may be stored in a non-transitory computer-readable medium such as system memory or another type of memory. In some cases, the code 1535 may not be directly executable by the processor 1540 but may cause a computer (e.g., when compiled and executed) to perform functions described herein. In some cases, the memory 1530 may contain, among other things, a BIOS which may control basic hardware or software operation such as the interaction with peripheral components or devices.

The processor 1540 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1540 may be configured to operate a memory array using a memory controller. In some other cases, a memory controller may be integrated into the processor 1540. The processor 1540 may be configured to execute computer-readable instructions stored in a memory (e.g., the memory 1530) to cause the device 1505 to perform various functions (e.g., functions or tasks supporting techniques for aircraft relaying). For example, the device 1505 or a component of the device 1505 may include a processor 1540 and memory 1530 coupled to the processor 1540, the processor 1540 and memory 1530 configured to perform various functions described herein.

The inter-station communications manager 1545 may manage communications with base stations 105 or other non-terrestrial network nodes, and may include a controller or scheduler for controlling communications with UEs 115 in cooperation with base stations 105, other non-terrestrial network nodes, aircraft, or a combination thereof. For example, the inter-station communications manager 1545 may coordinate scheduling for transmissions to UEs 115 for various interference mitigation techniques such as beamforming or joint transmission.

The communications manager 1520 may support wireless communication at a network node of an NTN in accordance with examples as disclosed herein. For example, the communications manager 1520 may be configured as or otherwise support a means for receiving, from a terrestrial base station or an aircraft, a first message including aircraft information for the aircraft and associated with a transmission of a second message, from a UE to the aircraft, including emergency information associated with the UE. The communications manager 1520 may be configured as or otherwise support a means for transmitting, to the UE, a third message including the aircraft information based on receiving the first message including the aircraft information.

By including or configuring the communications manager 1520 in accordance with examples as described herein, the device 1505 may support techniques for improved coverage (e.g., expanded cellular coverage for emergency communications), reliability, latency, data rates, power consumption, resource utilization efficiency, coordination between devices, and longer battery life, among other benefits.

In some examples, the communications manager 1520 may be configured to perform various operations (e.g., receiving, monitoring, transmitting) using or otherwise in cooperation with the transceiver 1515, the one or more antennas 1525, or any combination thereof. Although the communications manager 1520 is illustrated as a separate component, in some examples, one or more functions described with reference to the communications manager 1520 may be supported by or performed by the processor 1540, the memory 1530, the code 1535, or any combination thereof. For example, the code 1535 may include instructions executable by the processor 1540 to cause the device 1505 to perform various aspects of techniques for aircraft relaying as described herein, or the processor 1540 and the memory 1530 may be otherwise configured to perform or support such operations.

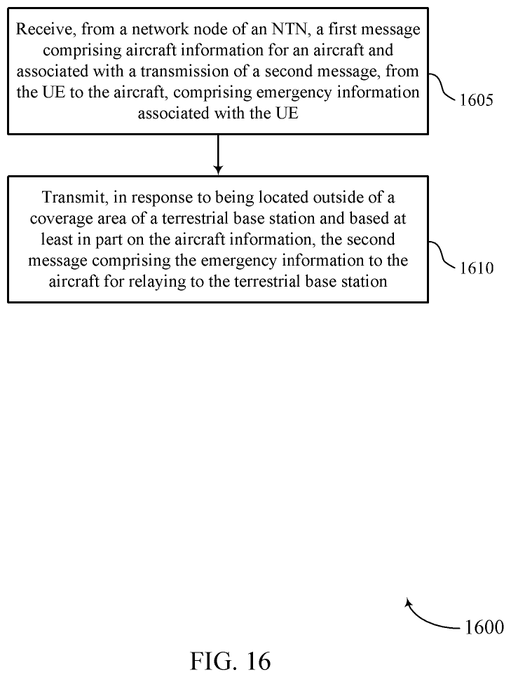

FIG. 16 shows a flowchart illustrating a method 1600 that supports techniques for aircraft relaying in accordance with aspects of the present disclosure. The operations of the method 1600 may be implemented by a UE or its components as described herein. For example, the operations of the method 1600 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1605, the method may include receiving, from a network node of an NTN, a first message including aircraft information for an aircraft and associated with a transmission of a second message, from the UE to the aircraft, including emergency information associated with the UE. The operations of 1605 may be performed in accordance with examples as disclosed herein. In some examples, aspects of the operations of 1605 may be performed by an aircraft component 625 as described with reference to FIG. 6.

At 1610, the method may include transmitting, in response to being located outside of a coverage area of a terrestrial base station and based on the aircraft information, the second message including the emergency information to the aircraft for relaying to the terrestrial base station. The operations of 1610 may be performed in accordance with examples as disclosed herein. In some examples, aspects of the operations of 1610 may be performed by an emergency component 630 as described with reference to FIG. 6.

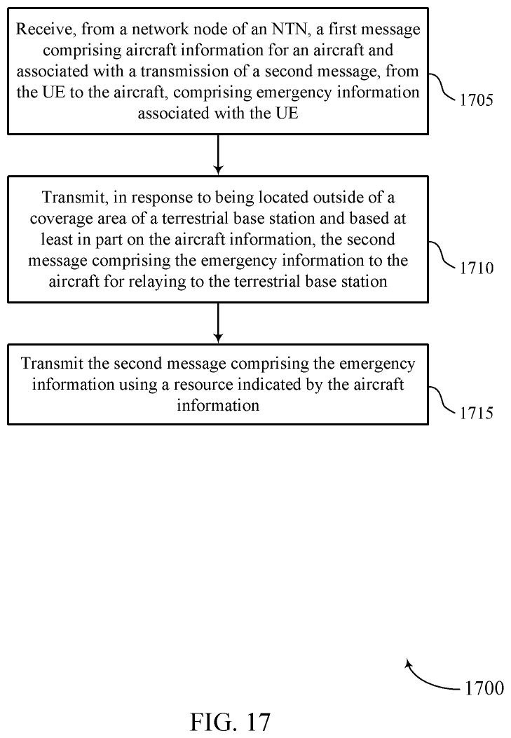

FIG. 17 shows a flowchart illustrating a method 1700 that supports techniques for aircraft relaying in accordance with aspects of the present disclosure. The operations of the method 1700 may be implemented by a UE or its components as described herein. For example, the operations of the method 1700 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1705, the method may include receiving, from a network node of an NTN, a first message including aircraft information for an aircraft and associated with a transmission of a second message, from the UE to the aircraft, including emergency information associated with the UE. The operations of 1705 may be performed in accordance with examples as disclosed herein. In some examples, aspects of the operations of 1705 may be performed by an aircraft component 625 as described with reference to FIG. 6.

At 1710, the method may include transmitting, in response to being located outside of a coverage area of a terrestrial base station and based on the aircraft information, the second message including the emergency information to the aircraft for relaying to the terrestrial base station. The operations of 1710 may be performed in accordance with examples as disclosed herein. In some examples, aspects of the operations of 1710 may be performed by an emergency component 630 as described with reference to FIG. 6.

At 1715, to transmit the second message including the emergency information, the method may include transmitting the second message including the emergency information using a resource indicated by the aircraft information. The operations of 1715 may be performed in accordance with examples as disclosed herein. In some examples, aspects of the operations of 1715 may be performed by an emergency component 630 as described with reference to FIG. 6.

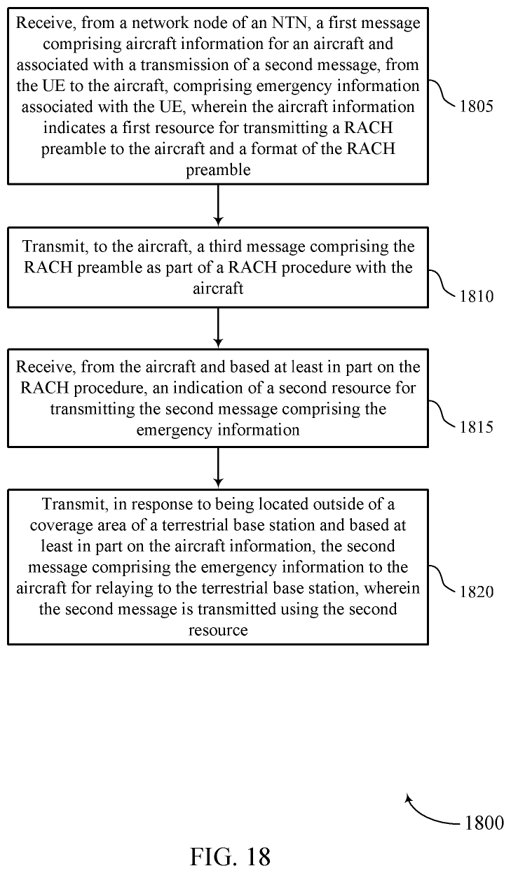

FIG. 18 shows a flowchart illustrating a method 1800 that supports techniques for aircraft relaying in accordance with aspects of the present disclosure. The operations of the method 1800 may be implemented by a UE or its components as described herein. For example, the operations of the method 1800 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1805, the method may include receiving, from a network node of an NTN, a first message including aircraft information for an aircraft and associated with a transmission of a second message, from the UE to the aircraft, including emergency information associated with the UE, where the aircraft information indicates a first resource for transmitting a RACH preamble to the aircraft and a format of the RACH preamble. The operations of 1805 may be performed in accordance with examples as disclosed herein. In some examples, aspects of the operations of 1805 may be performed by an aircraft component 625 as described with reference to FIG. 6.

At 1810, the method may include transmitting, to the aircraft, a third message including the RACH preamble as part of a RACH procedure with the aircraft. The operations of 1810 may be performed in accordance with examples as disclosed herein. In some examples, aspects of the operations of 1810 may be performed by a RACH component 635 as described with reference to FIG. 6.

At 1815, the method may include receiving, from the aircraft and based on the RACH procedure, an indication of a second resource for transmitting the second message including the emergency information. The operations of 1815 may be performed in accordance with examples as disclosed herein. In some examples, aspects of the operations of 1815 may be performed by a RACH component 635 as described with reference to FIG. 6.

At 1820, the method may include transmitting, in response to being located outside of a coverage area of a terrestrial base station and based on the aircraft information, the second message including the emergency information to the aircraft for relaying to the terrestrial base station, where the second message is transmitted using the second resource. The operations of 1820 may be performed in accordance with examples as disclosed herein. In some examples, aspects of the operations of 1820 may be performed by an emergency component 630 as described with reference to FIG. 6.

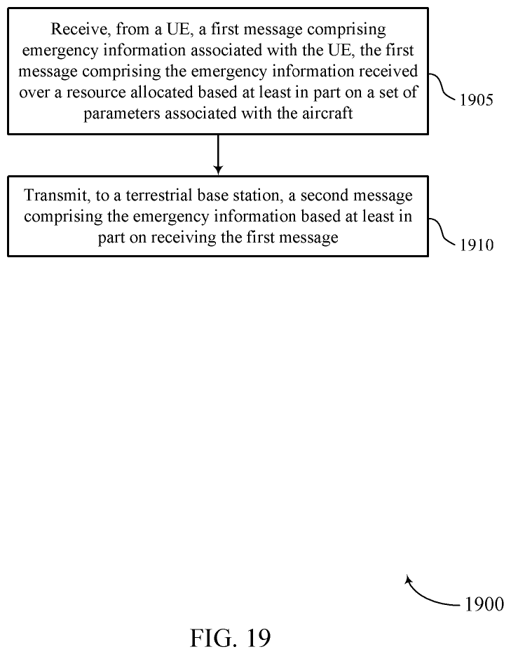

FIG. 19 shows a flowchart illustrating a method 1900 that supports techniques for aircraft relaying in accordance with aspects of the present disclosure. The operations of the method 1900 may be implemented by an aircraft or its components as described herein. For example, the operations of the method 1900 may be performed by an aircraft as described with reference to FIGS. 1 through 3 and 8 through 11. In some examples, an aircraft may execute a set of instructions to control the functional elements of the aircraft to perform the described functions. Additionally or alternatively, the aircraft may perform aspects of the described functions using special-purpose hardware.

At 1905, the method may include receiving, from a UE, a first message including emergency information associated with the UE, the first message including the emergency information received over a resource allocated based on a set of parameters associated with the aircraft. The operations of 1905 may be performed in accordance with examples as disclosed herein. In some examples, aspects of the operations of 1905 may be performed by an emergency component 1025 as described with reference to FIG. 10.

At 1910, the method may include transmitting, to a terrestrial base station, a second message including the emergency information based on receiving the first message. The operations of 1910 may be performed in accordance with examples as disclosed herein. In some examples, aspects of the operations of 1910 may be performed by a relay component 1030 as described with reference to FIG. 10.

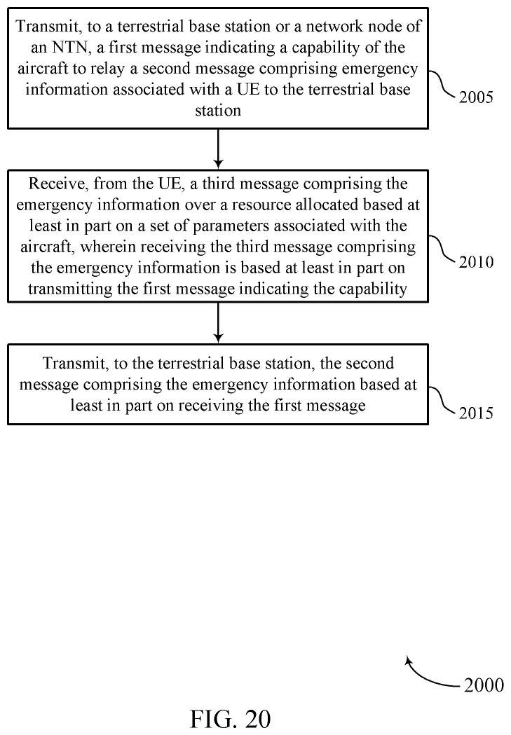

FIG. 20 shows a flowchart illustrating a method 2000 that supports techniques for aircraft relaying in accordance with aspects of the present disclosure. The operations of the method 2000 may be implemented by an aircraft or its components as described herein. For example, the operations of the method 2000 may be performed by an aircraft as described with reference to FIGS. 1 through 3 and 8 through 11. In some examples, an aircraft may execute a set of instructions to control the functional elements of the aircraft to perform the described functions. Additionally or alternatively, the aircraft may perform aspects of the described functions using special-purpose hardware.

At 2005, the method may include transmitting, to the terrestrial base station or a network node of an NTN, a first message indicating a capability of the aircraft to relay a second message including emergency information associated with a UE to the terrestrial base station. The operations of 2005 may be performed in accordance with examples as disclosed herein. In some examples, aspects of the operations of 2005 may be performed by a capability component 1035 as described with reference to FIG. 10.

At 2010, the method may include receiving, from the UE, a third message including the emergency information over a resource allocated based on a set of parameters associated with the aircraft, where receiving the third message including the emergency information is based at least in part on transmitting the first message indicating the capability. The operations of 2010 may be performed in accordance with examples as disclosed herein. In some examples, aspects of the operations of 2010 may be performed by an emergency component 1025 as described with reference to FIG. 10.

At 2015, the method may include transmitting, to the terrestrial base station, a second message including the emergency information based on receiving the first message. The operations of 2015 may be performed in accordance with examples as disclosed herein. In some examples, aspects of the operations of 2015 may be performed by a relay component 1030 as described with reference to FIG. 10.

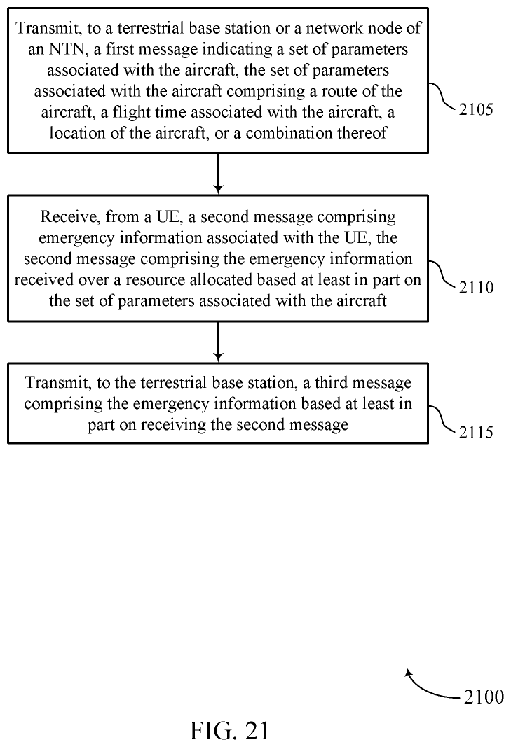

FIG. 21 shows a flowchart illustrating a method 2100 that supports techniques for aircraft relaying in accordance with aspects of the present disclosure. The operations of the method 2100 may be implemented by an aircraft or its components as described herein. For example, the operations of the method 2100 may be performed by an aircraft as described with reference to FIGS. 1 through 3 and 8 through 11. In some examples, an aircraft may execute a set of instructions to control the functional elements of the aircraft to perform the described functions. Additionally or alternatively, the aircraft may perform aspects of the described functions using special-purpose hardware.

At 2105, the method may include transmitting, to a terrestrial base station or a network node of an NTN, a first message indicating a set of parameters associated with the aircraft, the set of parameters associated with the aircraft comprising a route of the aircraft, a flight time associated with the aircraft, a location of the aircraft, or a combination thereof. The operations of 2105 may be performed in accordance with examples as disclosed herein. In some examples, aspects of the operations of 2105 may be performed by a parameter component 1040 as described with reference to FIG. 10.

At 2110, the method may include receiving, from a UE, a second message including emergency information associated with the UE, the second message including the emergency information received over a resource allocated based on the set of parameters associated with the aircraft. The operations of 2110 may be performed in accordance with examples as disclosed herein. In some examples, aspects of the operations of 2110 may be performed by an emergency component 1025 as described with reference to FIG. 10.

At 2115, the method may include transmitting, to the terrestrial base station, a third message including the emergency information based on receiving the first message. The operations of 2115 may be performed in accordance with examples as disclosed herein. In some examples, aspects of the operations of 2115 may be performed by a relay component 1030 as described with reference to FIG. 10.

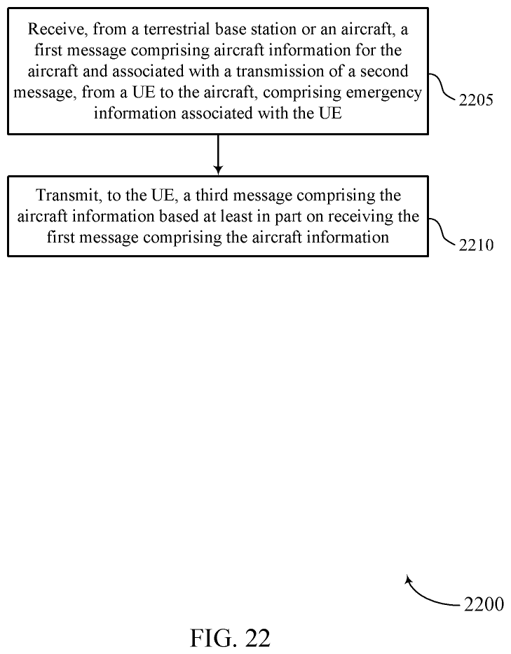

FIG. 22 shows a flowchart illustrating a method 2200 that supports techniques for aircraft relaying in accordance with aspects of the present disclosure. The operations of the method 2200 may be implemented by a network node of an NTN (e.g., an NTN node, a satellite) or its components as described herein. For example, the operations of the method 2200 may be performed by a NTN node as described with reference to FIGS. 1 through 3 and 12 through 15. In some examples, an NTN node may execute a set of instructions to control the functional elements of the NTN node to perform the described functions. Additionally or alternatively, the NTN node may perform aspects of the described functions using special-purpose hardware.

At 2205, the method may include receiving, from a terrestrial base station or an aircraft, a first message including aircraft information for the aircraft and associated with a transmission of a second message, from a UE to the aircraft, including emergency information associated with the UE. The operations of 2205 may be performed in accordance with examples as disclosed herein. In some examples, aspects of the operations of 2205 may be performed by a communication component 1425 as described with reference to FIG. 14.

At 2210, the method may include transmitting, to the UE, a third message including the aircraft information based on receiving the first message including the aircraft information. The operations of 2210 may be performed in accordance with examples as disclosed herein. In some examples, aspects of the operations of 2210 may be performed by an aircraft component 1430 as described with reference to FIG. 14.

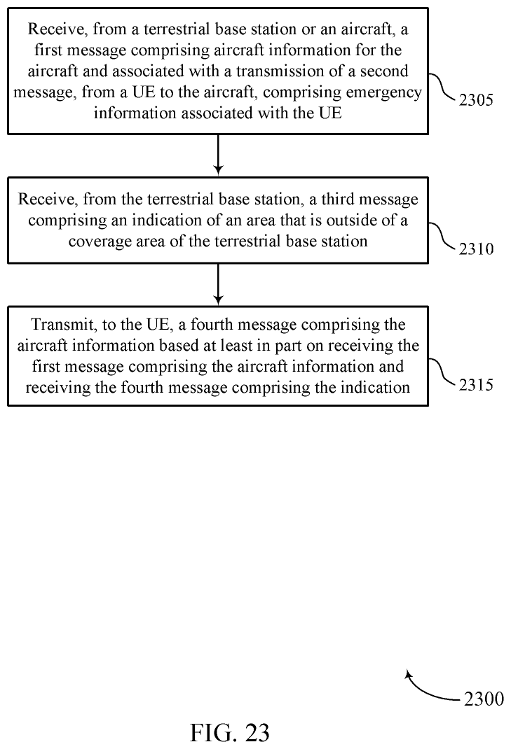

FIG. 23 shows a flowchart illustrating a method 2300 that supports techniques for aircraft relaying in accordance with aspects of the present disclosure. The operations of the method 2300 may be implemented by a network node of an NTN (e.g., an NTN node, a satellite) or its components as described herein. For example, the operations of the method 2300 may be performed by a NTN node as described with reference to FIGS. 1 through 3 and 12 through 15. In some examples, an NTN node may execute a set of instructions to control the functional elements of the NTN node to perform the described functions. Additionally or alternatively, the NTN node may perform aspects of the described functions using special-purpose hardware.

At 2305, the method may include receiving, from a terrestrial base station or an aircraft, a first message including aircraft information for the aircraft and associated with a transmission of a second message, from a UE to the aircraft, including emergency information associated with the UE. The operations of 2305 may be performed in accordance with examples as disclosed herein. In some examples, aspects of the operations of 2305 may be performed by a communication component 1425 as described with reference to FIG. 14.

At 2310, the method may include receiving, from the terrestrial base station, a third message including an indication of an area that is outside of a coverage area of the terrestrial base station. The operations of 2310 may be performed in accordance with examples as disclosed herein. In some examples, aspects of the operations of 2310 may be performed by a coverage component 1435 as described with reference to FIG. 14.

At 2315, the method may include transmitting, to the UE, a fourth message including the aircraft information based on receiving the first message including the aircraft information and receiving the third message comprising the indication. The operations of 2315 may be performed in accordance with examples as disclosed herein. In some examples, aspects of the operations of 2315 may be performed by an aircraft component 1430 as described with reference to FIG. 14.

The following provides an overview of aspects of the present disclosure:

Aspect 1: A method for wireless communication at a UE, comprising: receiving, from a network node of an NTN, a first message comprising aircraft information for an aircraft and associated with a transmission of a second message, from the UE to the aircraft, comprising emergency information associated with the UE; and transmitting, in response to being located outside of a coverage area of a terrestrial base station and based at least in part on the aircraft information, the second message comprising the emergency information to the aircraft for relaying to the terrestrial base station.

Aspect 2: The method of aspect 1, wherein the transmitting of the second message comprising the emergency information comprises: transmitting the second message comprising the emergency information using a resource indicated by the aircraft information.

Aspect 3: The method of aspect 2, further comprising: receiving, from the network node of the NTN and based at least in part on being in an idle state or an inactive state, a third message indicating for the UE to transmit the second message comprising the emergency information using the resource indicated by the aircraft information, wherein transmitting the second message uses the resource.

Aspect 4: The method of aspect 1, wherein the aircraft information indicates a first resource for transmitting a RACH preamble to the aircraft and a format of the RACH preamble, the method further comprising: transmitting, to the aircraft, a third message comprising the RACH preamble as part of a RACH procedure with the aircraft; and receiving, from the aircraft and based at least in part on the RACH procedure, an indication of a second resource for transmitting the second message comprising the emergency information, wherein the second message is transmitted using the second resource.

Aspect 5: The method of aspect 4, further comprising: receiving, from the network node of the NTN, a second indication to initiate the RACH procedure with the aircraft, wherein the third message comprising the RACH preamble is transmitted to the aircraft based at least in part on receiving the second indication.

Aspect 6: The method of any of aspects 4 through 5, further comprising: receiving, from the network node of the NTN, a third indication to refrain from initiating the RACH procedure with the network node of the NTN, wherein the third message comprising the RACH preamble is transmitted to the aircraft based at least in part on receiving the third indication.

Aspect 7: The method of any of aspects 1 through 6, further comprising: monitoring for the first message comprising the aircraft information from the network node of the NTN based at least in part on being located outside of the coverage area of the terrestrial base station, wherein the first message comprising the aircraft information is received while the UE is located outside of the coverage area of the terrestrial base station based at least in part on the monitoring.

Aspect 8: The method of any of aspects 1 through 7, further comprising: receiving, from the network node of the NTN, an indication that a first timing associated with transmitting the second message to the aircraft is asynchronous with a second timing associated with receiving the first message from the network node of the NTN, wherein transmitting the second message is based at least in part on receiving the indication.

Aspect 9: The method of any of aspects 1 through 8, wherein the aircraft information indicates a route of the aircraft, a flight time associated with the aircraft, a location of the aircraft, timing advance information associated with transmitting the second message comprising the emergency information, or a combination thereof.

Aspect 10: The method of any of aspects 1 through 9, further comprising: receiving, from the network node of the NTN, system information indicating that the first message comprising the aircraft information and control signaling are received from the network node of the NTN, wherein the network node of the NTN comprises a satellite.

Aspect 11: The method of any of aspects 1 through 10, wherein a resource used to transmit the second message comprising the emergency information is an uplink resource or a sidelink resource based at least in part on a configuration of the aircraft.

Aspect 12: The method of any of aspects 1 through 11, wherein the first message comprises second aircraft information for a second aircraft, the method further comprising: selecting the aircraft from at least the aircraft and the second aircraft to which to transmit the second message comprising the emergency information based at least in part on the aircraft information and the second aircraft information.

Aspect 13: A method for wireless communication at an aircraft, comprising: receiving, from a UE, a first message comprising emergency information associated with the UE, the first message comprising the emergency information received over a resource allocated based at least in part on a set of parameters associated with the aircraft; and transmitting, to a terrestrial base station, a second message comprising the emergency information based at least in part on receiving the first message.

Aspect 14: The method of aspect 13, further comprising: transmitting, to the terrestrial base station or a network node of an NTN, a third message indicating a capability of the aircraft to relay the second message comprising the emergency information to the terrestrial base station, wherein receiving the first message is based at least in part on transmitting the third message.

Aspect 15: The method of any of aspects 13 through 14, further comprising: transmitting, to the terrestrial base station or a network node of an NTN, a third message indicating the set of parameters associated with the aircraft, the set of parameters associated with the aircraft comprising a route of the aircraft, a flight time associated with the aircraft, a location of the aircraft, or a combination thereof, wherein receiving the first message is based at least in part on transmitting the third message.

Aspect 16: The method of any of aspects 13 through 15, further comprising: receiving, from the terrestrial base station or a network node of an NTN, an indication of the resource allocated for the first message comprising the emergency information; and monitoring the resource for the first message comprising the emergency information based at least in part on receiving the indication, wherein the first message comprising the emergency information is received over the resource based at least in part on the monitoring.

Aspect 17: The method of any of aspects 13 through 15, further comprising: receiving, from the terrestrial base station or a network node of an NTN, a first indication of a first resource for receiving a RACH preamble from the UE and a format of the RACH preamble; and monitoring, based at least in part on receiving the first indication, the first resource for the RACH preamble as part of a RACH procedure with the UE, wherein the resource is allocated for the first message comprising the emergency information based at least in part on the RACH procedure.

Aspect 18: The method of aspect 17, further comprising: receiving, from the UE and based at least in part on the monitoring, a third message comprising the RACH preamble as part of the RACH procedure with the UE; and transmitting, to the UE and based at least in part on performing the RACH procedure, a second indication of the resource allocated for the first message comprising the emergency information, wherein the first message comprising the emergency information is received over the resource based at least in part on transmitting the second indication.

Aspect 19: The method of any of aspects 13 through 18, further comprising: receiving, from the terrestrial base station or a network node of an NTN, an indication to enable reception of the first message comprising the emergency information from the UE and transmission of the second message comprising the emergency information to the terrestrial base station.

Aspect 20: The method of any of aspects 13 through 19, further comprising: enabling reception of the first message comprising the emergency information from the UE and transmission of the second message comprising the emergency information to the terrestrial base station based at least in part on a location of the aircraft satisfying a condition configured by the terrestrial base station or a network node of an NTN.

Aspect 21: The method of any of aspects 13 through 20, wherein the transmitting of the second message comprising the emergency information to the terrestrial base station comprises: transmitting the second message comprising the emergency information to a second aircraft or a network node of an NTN for relaying the second message comprising the emergency information to the terrestrial base station.

Aspect 22: A method for wireless communication at a network node of an NTN, comprising: receiving, from a terrestrial base station or an aircraft, a first message comprising aircraft information for the aircraft and associated with a transmission of a second message, from a UE to the aircraft, comprising emergency information associated with the UE; and transmitting, to the UE, a third message comprising the aircraft information based at least in part on receiving the first message comprising the aircraft information.

Aspect 23: The method of aspect 22, further comprising: receiving, from the terrestrial base station, a fourth message comprising an indication of an area that is outside of a coverage area of the terrestrial base station, wherein transmitting the third message comprising the aircraft information to the UE is based at least in part on receiving the fourth message.

Aspect 24: The method of any of aspects 22 through 23, wherein the transmitting of the third message comprising the aircraft information comprises: broadcasting the third message comprising the aircraft information to one or more UEs located in an area that is outside of a coverage area of the terrestrial base station, the one or more UEs comprising the UE.

Aspect 25: The method of any of aspects 22 through 24, wherein the aircraft information indicates a first resource for the UE to use to transmit the second message comprising the emergency information to the aircraft, a second resource for the UE to use to transmit a RACH preamble to the aircraft, a format of the RACH preamble, a route of the aircraft, a flight time associated with the aircraft, a location of the aircraft, timing advance information associated with transmitting the second message comprising the emergency information to the aircraft, or a combination thereof.

Aspect 26: An apparatus for wireless communication at a UE, comprising a processor; memory coupled with the processor; and instructions stored in the memory and executable by the processor to cause the apparatus to perform a method of any of aspects 1 through 12.

Aspect 27: An apparatus for wireless communication at a UE, comprising at least one means for performing a method of any of aspects 1 through 12.

Aspect 28: A non-transitory computer-readable medium storing code for wireless communication at a UE, the code comprising instructions executable by a processor to perform a method of any of aspects 1 through 12.

Aspect 29: An apparatus for wireless communication at an aircraft, comprising a processor; memory coupled with the processor; and instructions stored in the memory and executable by the processor to cause the apparatus to perform a method of any of aspects 13 through 21.

Aspect 30: An apparatus for wireless communication at an aircraft, comprising at least one means for performing a method of any of aspects 13 through 21.

Aspect 31: A non-transitory computer-readable medium storing code for wireless communication at an aircraft, the code comprising instructions executable by a processor to perform a method of any of aspects 13 through 21.

Aspect 32: An apparatus for wireless communication at a network node of an NTN, comprising a processor; memory coupled with the processor; and instructions stored in the memory and executable by the processor to cause the apparatus to perform a method of any of aspects 22 through 25.

Aspect 33: An apparatus for wireless communication at a network node of an NTN, comprising at least one means for performing a method of any of aspects 22 through 25.

Aspect 34: A non-transitory computer-readable medium storing code for wireless communication at a network node of an NTN, the code comprising instructions executable by a processor to perform a method of any of aspects 22 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a network node of a non-terrestrial network, a first message comprising aircraft information for an aircraft and associated with a transmission of a second message, from the UE to the aircraft, comprising emergency information associated with the UE; and
transmitting, in response to being located outside of a coverage area of a terrestrial base station and based at least in part on the aircraft information, the second message comprising the emergency information to the aircraft for relaying to the terrestrial base station.

2. The method of claim 1, wherein the transmitting of the second message comprising the emergency information comprises:
transmitting the second message comprising the emergency information using a resource indicated by the aircraft information.

3. The method of claim 2, further comprising:
receiving, from the network node of the non-terrestrial network and based at least in part on being in an idle state or an inactive state, a third message indicating for the UE to transmit the second message comprising the emergency information using the resource indicated by the aircraft information, wherein transmitting the second message uses the resource.

4. The method of claim 1, wherein the aircraft information indicates a first resource for transmitting a random access channel preamble to the aircraft and a format of the random access channel preamble, the method further comprising:
transmitting, to the aircraft, a third message comprising the random access channel preamble as part of a random access channel procedure with the aircraft; and
receiving, from the aircraft and based at least in part on the random access channel procedure, an indication of a second resource for transmitting the second message comprising the emergency information, wherein the second message is transmitted using the second resource.

5. The method of claim 4, further comprising:
receiving, from the network node of the non-terrestrial network, a second indication to initiate the random access channel procedure with the aircraft, wherein the third message comprising the random access channel preamble is transmitted to the aircraft based at least in part on receiving the second indication.

6. The method of claim 4, further comprising:
receiving, from the network node of the non-terrestrial network, a second indication to refrain from initiating the random access channel procedure with the network node of the non-terrestrial network, wherein the third message comprising the random access channel preamble is transmitted to the aircraft based at least in part on receiving the second indication.

7. The method of claim 1, further comprising:
monitoring for the first message comprising the aircraft information from the network node of the non-terrestrial network based at least in part on being located outside of the coverage area of the terrestrial base station, wherein the first message comprising the aircraft information is received while the UE is located outside of the coverage area of the terrestrial base station based at least in part on the monitoring.

8. The method of claim 1, further comprising:
receiving, from the network node of the non-terrestrial network, an indication that a first timing associated with transmitting the second message to the aircraft is asynchronous with a second timing associated with receiving the first message from the network node of the non-terrestrial network, wherein transmitting the second message is based at least in part on receiving the indication.

9. The method of claim 1, wherein the aircraft information indicates a route of the aircraft, a flight time associated with the aircraft, a location of the aircraft, timing advance information associated with transmitting the second message comprising the emergency information, or a combination thereof.

10. The method of claim 1, further comprising:
receiving, from the network node of the non-terrestrial network, system information indicating that the first message comprising the aircraft information and control signaling are received from the network node of the non-terrestrial network, wherein the network node of the non-terrestrial network comprises a satellite.

11. The method of claim 1, wherein a resource used to transmit the second message comprising the emergency information is an uplink resource or a sidelink resource based at least in part on a configuration of the aircraft.

12. The method of claim 1, wherein the first message comprises second aircraft information for a second aircraft, the method further comprising:
selecting the aircraft from at least the aircraft and the second aircraft to which to transmit the second message comprising the emergency information based at least in part on the aircraft information and the second aircraft information.

13. A method for wireless communication at an aircraft, comprising:
receiving, from a user equipment (UE), a first message comprising emergency information associated with the UE, the first message comprising the emergency information received over a resource allocated based at least in part on a set of parameters associated with the aircraft; and
transmitting, to a terrestrial base station, a second message comprising the emergency information based at least in part on receiving the first message.

14. The method of claim 13, further comprising:
transmitting, to the terrestrial base station or a network node of a non-terrestrial network, a third message indicating a capability of the aircraft to relay the second message comprising the emergency information to the terrestrial base station, wherein receiving the first message is based at least in part on transmitting the third message.

15. The method of claim 13, further comprising:
transmitting, to the terrestrial base station or a network node of a non-terrestrial network, a third message indicating the set of parameters associated with the aircraft, the set of parameters associated with the aircraft comprising a route of the aircraft, a flight time associated with the aircraft, a location of the aircraft, or a combination thereof, wherein receiving the first message is based at least in part on transmitting the third message.

16. The method of claim 13, further comprising:
receiving, from the terrestrial base station or a network node of a non-terrestrial network, an indication of the resource allocated for the first message comprising the emergency information; and
monitoring the resource for the first message comprising the emergency information based at least in part on receiving the indication, wherein the first message comprising the emergency information is received over the resource based at least in part on the monitoring.

17. The method of claim 13, further comprising:
receiving, from the terrestrial base station or a network node of a non-terrestrial network, a first indication of a first resource for receiving a random access channel preamble from the UE and a format of the random access channel preamble; and
monitoring, based at least in part on receiving the first indication, the first resource for the random access channel preamble as part of a random access channel procedure with the UE, wherein the resource is allocated for the first message comprising the emergency information based at least in part on the random access channel procedure.

18. The method of claim 17, further comprising:
receiving, from the UE and based at least in part on the monitoring, a third message comprising the random access channel preamble as part of the random access channel procedure with the UE; and
transmitting, to the UE and based at least in part on performing the random access channel procedure, a second indication of the resource allocated for the first message comprising the emergency information, wherein the first message comprising the emergency information is received over the resource based at least in part on transmitting the second indication.

19. The method of claim 13, further comprising:
receiving, from the terrestrial base station or a network node of a non-terrestrial network, an indication to enable reception of the first message comprising the emergency information from the UE and transmission of the second message comprising the emergency information to the terrestrial base station.

20. The method of claim 13, further comprising:
enabling reception of the first message comprising the emergency information from the UE and transmission of the second message comprising the emergency information to the terrestrial base station based at least in part on a location of the aircraft satisfying a condition configured by the terrestrial base station or a network node of a non-terrestrial network.

21. The method of claim 13, wherein the transmitting of the second message comprising the emergency information to the terrestrial base station comprises:
transmitting the second message comprising the emergency information to a second aircraft or a network node of a non-terrestrial network for relaying the second message comprising the emergency information to the terrestrial base station.

22. A method for wireless communication at a network node of a non-terrestrial network, comprising:
receiving, from a terrestrial base station or an aircraft, a first message comprising aircraft information for the aircraft and associated with a transmission of a second message, from a user equipment (UE) to the aircraft, comprising emergency information associated with the UE; and
transmitting, to the UE, a third message comprising the aircraft information based at least in part on receiving the first message comprising the aircraft information.

23. The method of claim 22, further comprising:
receiving, from the terrestrial base station, a fourth message comprising an indication of an area that is outside of a coverage area of the terrestrial base station, wherein transmitting the third message comprising the aircraft information to the UE is based at least in part on receiving the fourth message.

24. The method of claim 22, wherein the transmitting of the third message comprising the aircraft information comprises:
broadcasting the third message comprising the aircraft information to one or more UEs located in an area that is outside of a coverage area of the terrestrial base station, the one or more UEs comprising the UE.

25. The method of claim 22, wherein the aircraft information indicates a first resource for the UE to use to transmit the second message comprising the emergency information to the aircraft, a second resource for the UE to use to transmit a random access channel preamble to the aircraft, a format of the random access channel preamble, a route of the aircraft, a flight time associated with the aircraft, a location of the aircraft, timing advance information associated with transmitting the second message comprising the emergency information to the aircraft, or a combination thereof.

26. An apparatus for wireless communication at a user equipment (UE), comprising:
a processor;
memory coupled with the processor; and
instructions stored in the memory and operable, when executed by the processor, to cause the apparatus to:
receive, from a network node of a non-terrestrial network, a first message comprising aircraft information for an aircraft and associated with a transmission of a second message, from the UE to the aircraft, comprising emergency information associated with the UE; and
transmit, in response to being located outside of a coverage area of a terrestrial base station and based at least in part on the aircraft information, the second message comprising the emergency information to the aircraft for relaying to the terrestrial base station.

27. The apparatus of claim 26, wherein the instructions to transmit the second message comprising the emergency information are operable, when executed by the processor, to cause the apparatus to:
transmit the second message comprising the emergency information using a resource indicated by the aircraft information.

28. The apparatus of claim 26, wherein the aircraft information indicates a first resource for transmitting a random access channel preamble to the aircraft and a format of the random access channel preamble, and the instructions are further operable, when executed by the processor, to cause the apparatus to:
transmit, to the aircraft, a third message comprising the random access channel preamble as part of a random access channel procedure with the aircraft; and
receive, from the aircraft and based at least in part on the random access channel procedure, an indication of a second resource for transmitting the second message comprising the emergency information, wherein the second message is transmitted using the second resource.

29. The apparatus of claim 26, wherein the instructions are further operable, when executed by the processor, to cause the apparatus to:
monitor for the first message comprising the aircraft information from the network node of the non-terrestrial network based at least in part on being located outside of the coverage area of the terrestrial base station, wherein the first message comprising the aircraft information is received while the UE is located outside of the coverage area of the terrestrial base station based at least in part on the monitoring.

30. The apparatus of claim 26, wherein the aircraft information indicates a route of the aircraft, a flight time associated with the aircraft, a location of the aircraft, timing advance information associated with transmitting the second message comprising the emergency information, or a combination thereof.
